(19) United States
(12) Patent Application Publication
(10) Pub. No.: US 2022/0135025 A1
(43) Pub. Date: May 5, 2022

(54) PARKING ASSIST DEVICE

(71) Applicant: DENSO CORPORATION, Kariya-city (JP)

(72) Inventor: Takamasa Hidaka, Kariya-city (JP)

(21) Appl. No.: 17/578,999

(22) Filed: Jan. 19, 2022

Related U.S. Application Data
(63) Continuation of application No. PCT/JP2020/028523, filed on Jul. 22, 2020.

(30) Foreign Application Priority Data
Jul. 26, 2019 (JP) 2019-138002
Sep. 30, 2019 (JP) 2019-179654

(51) Int. Cl. B60W 30/06; G08G 1/16; G01C 21/34; B60W 30/09; B60W 50/02

(52) U.S. Cl. CPC B60W 30/06; G08G 1/166; B60W 2520/04; B60W 30/09; B60W 50/0205; G01C 21/3461

(57) ABSTRACT

A parking assist device is configured to assist auto-parking for a plurality of self-driving vehicles. The device includes: a guide setting unit configured to set a guide route for each of the plurality of self-driving vehicles; an abnormality detecting unit configured to detect abnormality relating to parking assist; a non-overlapping setting unit configured to, when the abnormality concerning a particular vehicle of the plurality of self-driving vehicle is detected, set a non-overlapping route, as the guide route, for the particular vehicle such that the non-overlapping route does not overlap with any other guide routes set for remaining self-driving vehicles; and a route transmission unit configured to transmit the guide route to each of the plurality of self-driving vehicles.

### CROSS REFERENCE TO RELATED APPLICATIONS

This application is a continuation application of International Patent Application No. PCT/JP2020/028523 filed on Jul. 22, 2020, which designated the U.S. and claims the benefit of priority from Japanese Patent Application No. 2019-138002 filed on Jul. 26, 2019 and Japanese Patent Application No. 2019-179654 filed on Sep. 30, 2019. The entire disclosure of all of the above application is incorporated herein by reference.

### TECHNICAL FIELD

The present disclosure relates to a parking assist device.

### BACKGROUND ART

There has been known a parking assist device that is configured to automatically determine a travel route to an empty parking space in a parking lot and guide an self-driving vehicle to the empty parking space.

### SUMMARY

One aspect of the present disclosure is a parking assist device configured to assist auto-parking for a plurality of self-driving vehicles. The device includes: a guide setting unit configured to set a guide route for each of the plurality of self-driving vehicles, the plurality of self-driving vehicles configured to perform automated driving in a parking lot according to the guide route set by the guide setting unit; an abnormality detecting unit configured to detect abnormality relating to parking assist; a non-overlapping setting unit configured to, when the abnormality concerning a particular vehicle of the plurality of self-driving vehicle is detected, set a non-overlapping route, as the guide route, for the particular vehicle such that the non-overlapping route does not overlap with any other guide routes set for remaining self-driving vehicles; and a route transmission unit configured to transmit the guide route to each of the plurality of self-driving vehicles. The guide setting unit is configured to set the guide route such that the guide route for each of the remaining self-driving vehicles is allowed to overlap with each other except the non-overlapping route.

### BRIEF DESCRIPTION OF DRAWINGS

The above and other objects, features and advantages of the present disclosure will become more apparent from the following detailed description made with reference to the accompanying drawings.

FIG. 1 is a block diagram illustrating a configuration of a parking assist system.

FIG. 2 is a plan diagram illustrating one example of a parking lot.

FIG. 3 illustrates one example of a loading-and-unloading flowchart.

FIG. 4 illustrates one example of a travel route switching flowchart.

FIG. 5 is a plan view of a parking lot.

FIG. 6 is a block diagram illustrating a configuration of a parking assist system.

FIG. 7 is a functional block diagram of a controller of a administrator unit.

FIG. 8 is a flowchart of parking setting processing performed by the administrator unit.

FIG. 9 is a flowchart of non-overlapping loading processing in the parking setting processing.

FIG. 10 is a flowchart of normal loading processing in the parking setting processing.

FIG. 11 is a flowchart of automatic parking processing performed by an self-driving vehicle.

FIG. 12 is a flowchart of unloading setting processing performed by the administrator unit.

FIG. 13 is a flowchart of non-overlapping unloading processing in the unloading setting processing.

FIG. 14 is a flowchart of normal unloading processing in the unloading setting processing.

FIG. 15 is a flowchart of automatic unloading processing performed by an self-driving vehicle.

FIG. 16 is a flowchart of a modification of parking setting processing performed by the administrator unit.

FIG. 17 is a flowchart of non-overlapping loading processing in the parking setting processing of FIG. 16.

FIG. 18 is a flowchart of normal loading processing in the parking setting processing of FIG. 16.

FIG. 19A conceptually illustrates a case where all paths in the parking lot are available.

FIG. 19B conceptually illustrates path setting when another vehicle executing the non-overlapping unloading processing exists.

FIG. 19C conceptually illustrates path setting when the non-overlapping loading processing is performed.

FIG. 19D conceptually illustrates release of a traveled route.

### DESCRIPTION OF EMBODIMENTS

To begin with, a relevant technology will be described only for understanding the following embodiments.

For the above parking assist device, a plurality of self-driving vehicles need to travel along their guiding routes that overlap each other or distances between the vehicles needs to be narrowed in order to improve auto-parking efficiency. Through detailed investigations, however, the inventors have found the following problems. Although the parking assist device needs to prepare for a situation where abnormality occurs in a plurality of self-driving vehicles, if the following distance or a guide route is set considering safety, parking efficiency is sacrificed.

One aspect of this disclosure is to provide a safe guide route generation function while maintaining high parking efficiency as much as possible in a technique of supporting parking of an self-driving vehicle in a parking lot.

As described above, the one aspect of the present disclosure is a parking assist device configured to assist auto-parking for a plurality of self-driving vehicles. The device includes: a guide setting unit configured to set a guide route for each of the plurality of self-driving vehicles, the plurality of self-driving vehicles configured to perform automated driving in a parking lot according to the guide route set by the guide setting unit; an abnormality detecting unit configured to detect abnormality relating to parking assist; a non-overlapping setting unit configured to, when the abnormality concerning a particular vehicle of the plurality of self-driving vehicle is detected, set a non-overlapping route, as the guide route, for the particular vehicle such that the non-overlapping route does not overlap with any other guide routes set for remaining self-driving vehicles; and a route transmission unit configured to transmit the guide route to each of the plurality of self-driving vehicles. The guide setting unit is configured to set the guide route such that the guide route for each of the remaining self-driving vehicles is allowed to overlap with each other except the non-overlapping route.

Another aspect of the present disclosure is a parking assist device configured to assist auto-parking for a plurality of self-driving vehicles. The device includes: at least one processor; and at least one memory coupled to the at least one processor and storing program instructions that, when executed by the at least one processor, cause the at least one processor to: set a guide route for each of the plurality of self-driving vehicles, the plurality of self-driving vehicles configured to perform automated driving in a parking lot according to the set guide route; detect abnormality relating to parking assist; when the abnormality concerning a particular vehicle of the plurality of self-driving vehicle is detected, set a non-overlapping route, as the guide route, for the particular vehicle such that the non-overlapping route does not overlap with any other guide routes set for remaining self-driving vehicles; and transmit the guide route to each of the plurality of self-driving vehicles. The program instructions further cause the at least one processor to set the guide route such that the guide route for each of the remaining self-driving vehicles is allowed to overlap with each other except the non-overlapping route.

According to such a configuration, since the guide route for the particular vehicle is set to be the non-overlapping route, the particular vehicle can be prevented from coming into contact with other self-driving vehicles (i.e., the remaining self-driving vehicles). The non-overlapping setting unit may change the guide route for the particular vehicle to the non-overlapping route, or may change a guide route for each of the remaining self-driving vehicles other than the particular vehicle so that the guide route for the particular vehicle results in the non-overlapping route. When all of the plurality of self-driving vehicles are the particular vehicles, the non-overlapping route may be set for all the self-driving vehicles.

Next, a plurality of embodiments of the present disclosure are now described with reference to drawings.

### 1. Summary

Summary of the disclosure is now described.

### System Block Diagram

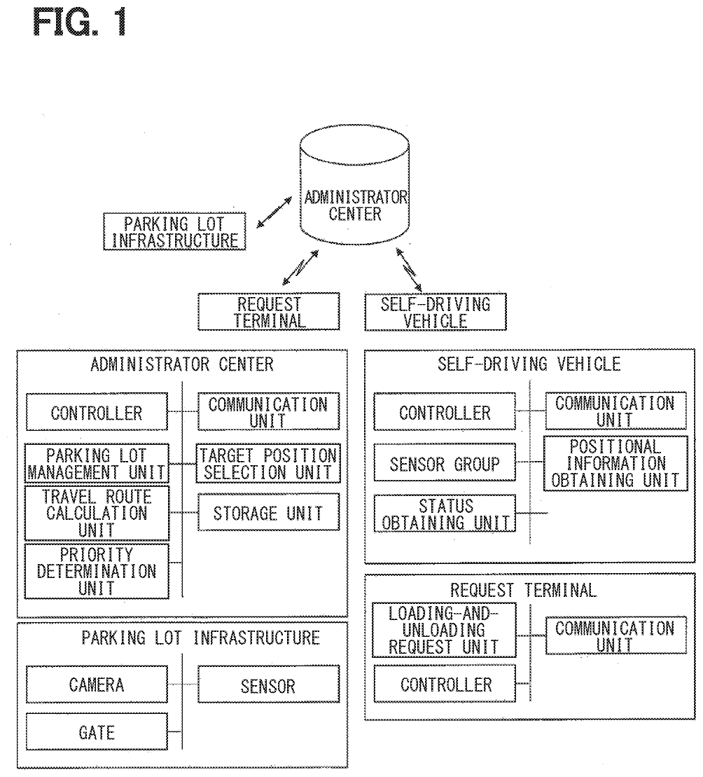

An administrator center (an administrator unit 39 as described later), which is a server to manage auto-parking for a plurality of vehicles as illustrated in FIG. 1, determines a travel route to an empty parking space in a parking lot. The administrator center is configured to be radio-communicable with a parking lot infrastructure (infrastructure 41 as described later), a request terminal (terminal device 43 as described later), and an self-driving vehicle (18). The administrator center includes a computer (CPU) and a memory. The administrator center further includes a controller (47), a parking lot management unit, a travel route calculation unit, a priority determination unit, a communication unit, a target position selection unit, and a storage unit. The storage unit stores map information of the parking lot.

The parking lot infrastructure is an infrastructure provided in the parking lot. The parking lot infrastructure includes a camera, a sensor, a gate, and a communication unit.

The self-driving vehicle performs auto-parking in the parking lot based on communication with the administrator center. The self-driving vehicle includes a computer (CPU) and a memory. The self-driving vehicle further includes a controller (69), a sensor group (71), a status obtaining unit, a communication unit (75), and a positional information obtaining unit (73).

The request terminal, which is an operation terminal placed in the parking lot or a portable terminal owned by a user, transmits a loading request or an unloading request to the administrator center based on user operation. The request terminal includes a computer (CPU) and a memory. The request terminal further includes a controller, a loading-and-unloading request unit, and a communication unit.

### Parking Lot Configuration Diagram

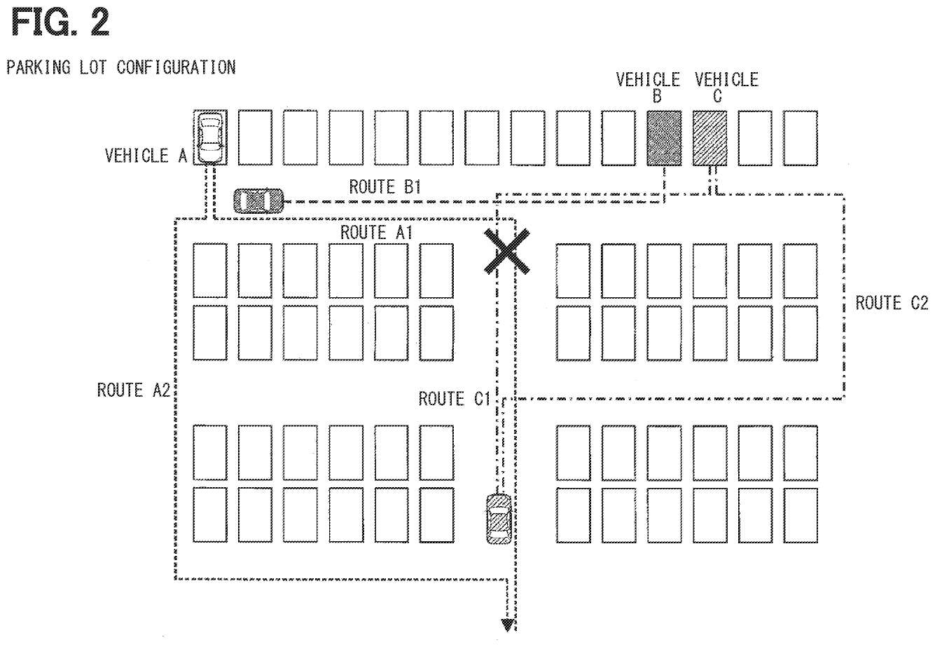

As illustrated in FIG. 2, a vehicle A is an self-driving vehicle that moves from a loading vehicle room to a target parking position through a route A1. A vehicle B is an self-driving vehicle that moves from a predetermined position in a parking space to an unloading vehicle room through a route B1. A vehicle C is an self-driving vehicle that moves from a predetermined position in the parking space to an unloading vehicle room through a route C1.

The administrator center generates guide routes for the vehicles A, B, and C and transmits the guide routes to each of the vehicles A, B, and C. When detecting delay in communication with an self-driving vehicle or abnormality in a sensor or the like of an self-driving vehicle, the administrator center generates an avoidance route for the self-driving vehicle to prevent overlapping with a guide route for another self-driving vehicle and transmits the avoidance route to such an self-driving vehicle.

For example, the administrator center newly generates a route A2 for the vehicle A and transmits the route A2 to the vehicle A because the route A1 overlaps both the route B1 and the route C1. In addition, the administrator center newly generates a route C2 for the vehicle C and transmits the route C2 to the vehicle C because the route C1 overlaps both the route A1 and the route B1.

To generate a non-overlapping avoidance route, the administrator center reads travel routes for other vehicles in the parking lot, disables the relevant vehicle to travel any of the travel routes for other vehicles, disables traveling of the travel routes for other vehicles and thus narrows down travelable routes in a parking map. The administrator center generates a travel route from the travelable routes according to a predetermined criterion. When the travel route is failed to be generated from the travelable routes, the administrator center generates the travel route again after waiting for a predetermined time.

The administrator center continuously monitors presence or absence of abnormality in a vehicle or presence or absence of communication delay during automated valet parking in order to generate a safe guide route and switch a travel route to the safe guide route. When the abnormality or the communication delay occurs, a stop command is immediately sent to a vehicle from a controlling gear to switch a travel route and a criterion for generating a travel route. The vehicle transmits a travel state (a stop state and positional information) to the controlling gear. While securing a route for a vehicle failed to be confirmed to stop, the administrator center generates safe routes for other vehicles using other routes. The administrator center transmits a safe route to a vehicle failed to be confirmed to stop to achieve automated valet parking. The administrator center continuously monitors whether an abnormal state is released, and returns the criterion to a criterion for generating a travel route in a normal state if the abnormal state is released.

### Loading-and-Unloading Flowchart

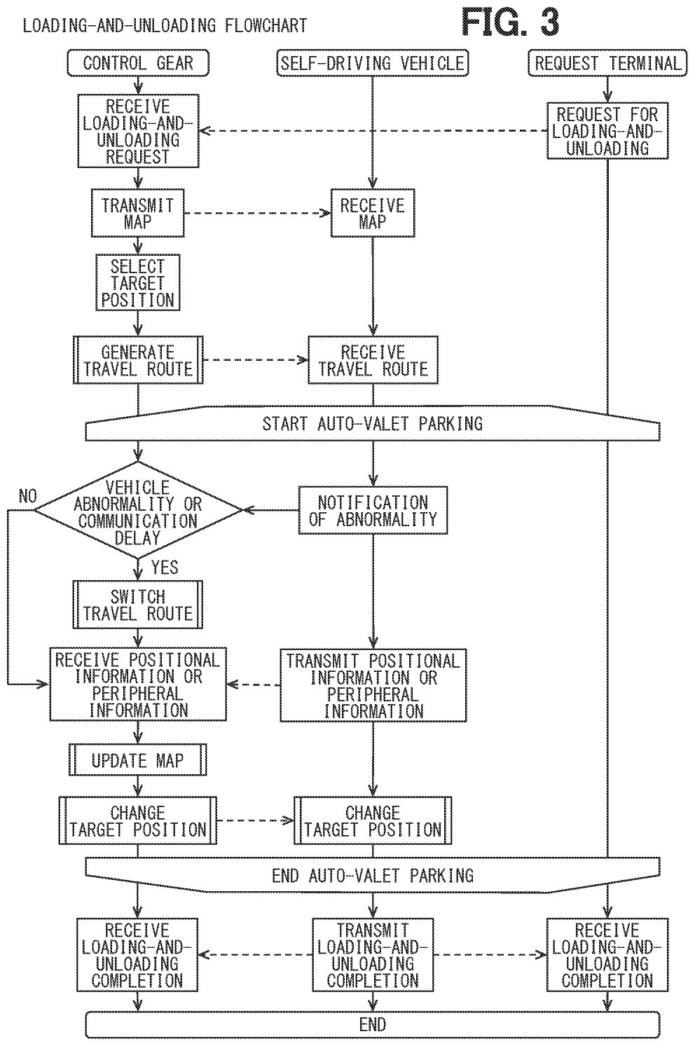

(1) As illustrated in FIG. 3, the administrator center (i.e., control gear) transmits a map to a self-driving vehicle upon receiving a loading-and-unloading request from a request terminal. The self-driving vehicle receives and stores the map transmitted from the administrator center. The administrator center selects a target position of the self-driving vehicle. The administrator center selects an empty parking space as the target position for a loading vehicle. The administrator center selects an unloading vehicle room as the target position for an unloading vehicle. The administrator center performs travel route generation processing to generate a travel route to a target position (i.e., guide route). Since no abnormality is detected at this time, a travel route is generated so as to be allowed to overlap a travel route for another vehicle. The administrator center transmits the generated travel route to the self-driving vehicle. The self-driving vehicle receives and stores the travel route transmitted from the administrator center. The self-driving vehicle then performs the automated valet parking while transmitting data of, for example, current location to the administrator center.

(2) When detecting abnormality in a sensor or the like during execution of automated valet parking, the self-driving vehicle informs the administrator center of the abnormality. When being informed of the abnormality from the self-driving vehicle, or when detecting delay in communication with the self-driving vehicle, the administrator center performs processing for switching to a safe travel route. The safe travel route is, for example, a travel route that does not overlap a travel route for another vehicle. The administrator center performs processing of updating map information based on positional information or peripheral information transmitted from the self-driving vehicle. For example, the administrator center updates the map information such that a position of the self-driving vehicle, in which abnormality has occurred, is on a travel-prohibited route. The administrator center changes a target position and performs processing of informing the self-driving vehicle of the changed target position. The self-driving vehicle performs automated valet parking based on the new target position and the new travel route.

(3) When the self-driving vehicle reaches the target position and when the automated valet parking is thus ended, the self-driving vehicle transmits a loading-and-unloading completion notice to both the administrator center and the request terminal.

### Travel Route Switching Flowchart

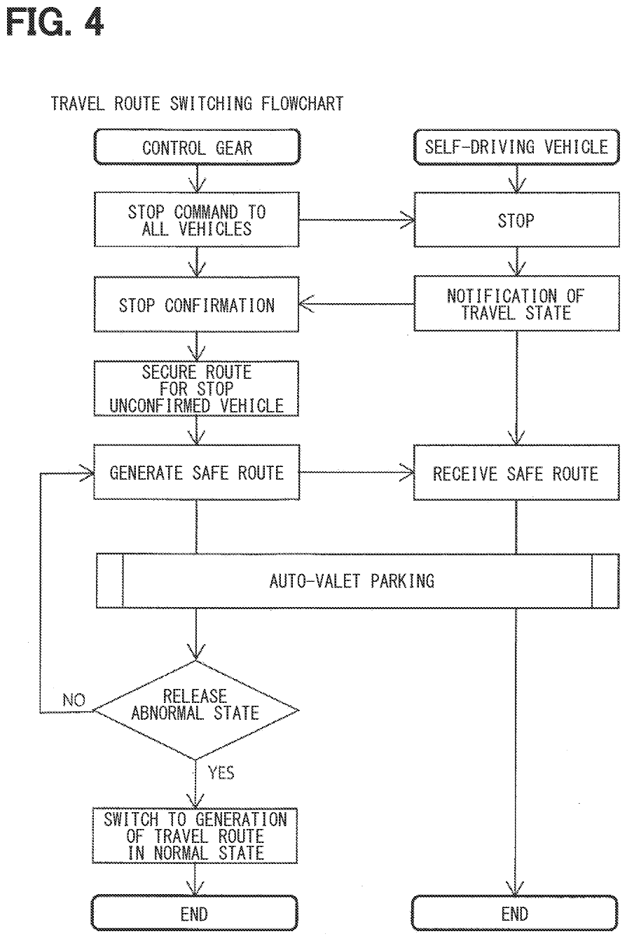

(1) As illustrated in FIG. 4, the administrator center transmits a stop command to all vehicles that are performing the automated valet parking. The self-driving vehicle stops running upon receiving the stop command from the administrator center. The self-driving vehicle informs the administrator center of its travel state being a stopped state. The administrator center confirms that the self-driving vehicle is in the stopped state. The administrator center generates a safe travel route for the self-driving vehicle confirmed to stop running and transmits the safe travel route to that self-driving vehicle while securing a travel route along which an self-driving vehicle unconfirmed to stop running is moving. The self-driving vehicle performs automated valet parking based on the new travel route.

(2) When confirming release of the abnormal state, such as resolution of communication delay, the control center switches a mode to a mode of generating a travel route in the normal state and then ends the switching operation. The control center operates in a mode of generating the safe travel route while the abnormal state is not released.

### 2. Embodiment

Description is now given on one example of a detailed embodiment corresponding to the summary.

### 2-1. Configuration of Parking Assist System 1

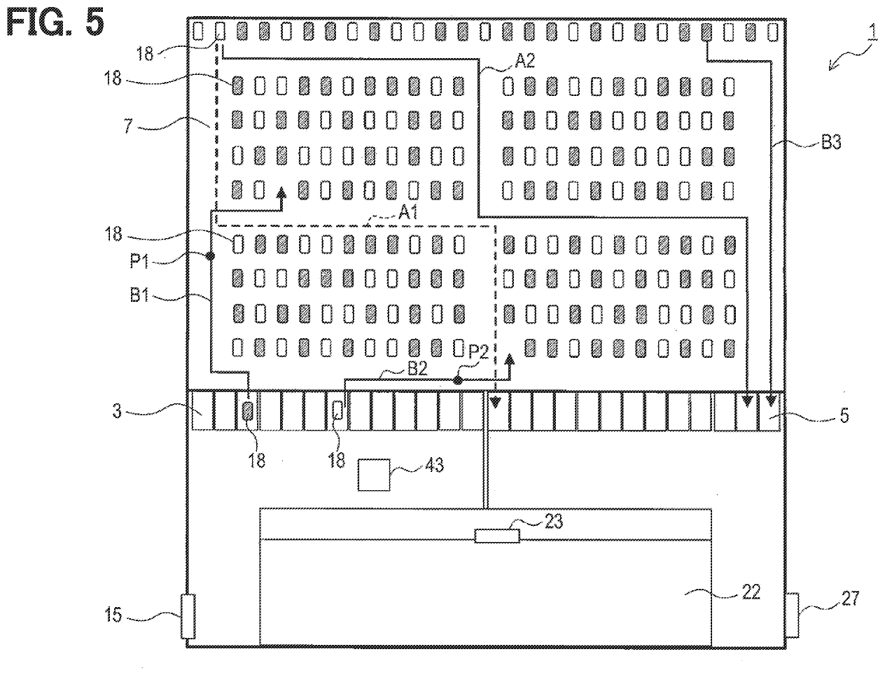

A configuration of a parking assist system 1 is described with reference to FIGS. 5 to 7. As illustrated in FIG. 5, the parking assist device 1 includes a loading vehicle room 3 set in an exit area as a region where a user gets off, an unloading vehicle room 5 set in a boarding area as a region where a user gets on, and a parking lot 7. In the following, the region including the loading vehicle room 3, the unloading vehicle room 5, and the parking lot 7 may be mentioned as a relevant parking lot.

The loading vehicle room 3 and the unloading vehicle room 5 each have a plurality of sections. The loading vehicle room 3 is connected to the outside of the parking assist system 1 via an entrance 15. An self-driving vehicle 18 can externally enter the loading vehicle room 3 through the entrance 15. The self-driving vehicle 18 has an automated valet parking function.

The self-driving vehicle 18 may merely perform the automated valet parking function within the relevant parking lot, and need not have a function of performing automated driving outside the relevant parking lot. The automated valet parking function includes a function of traveling from the loading vehicle room 3 to a parking position in the parking lot 7 and parking there by automated driving, and a function of traveling from the parking position in the parking lot 7 to the unloading vehicle room 5 by the automated driving.

The automated valet parking function specifically includes a function of repeatedly obtaining positional information of the self-driving vehicle 18 and transmitting the positional information to a administrator unit 39 as the parking assist device of the disclosure, and a function of receiving a guide route from the administrator unit 39 and controlling the self-driving vehicle 18 to travel according to the guide route. The positional information of the self-driving vehicle 18 indicates an estimation result of current location of the self-driving vehicle 18, for example, contains a coordinate value of the self-driving vehicle 18 in the region of the relevant parking lot.

The loading vehicle room 3 and the unloading vehicle room 5 are each adjacent to an entrance 23 of a facility 22 such as a store. An occupant of the self-driving vehicle 18 loaded in the loading vehicle room 3 can walk to the entrance 23 after getting off the self-driving vehicle 18.

The unloading vehicle room 5 is connected to the outside of the parking assist system 1 through an exit 27. The self-driving vehicle 18 can move from the unloading vehicle room 5 to the outside of the parking assist system 1 through the exit 27. The unloading vehicle room 5 is adjacent to the entrance 23. An occupant can walk to the unloading vehicle room 5 through the entrance 23.

The parking lot 7 is a place in which a plurality of self-driving vehicles 18 can be parked. A plurality of sections are provided in the parking lot 7. A plurality of paths, through each of which the self-driving vehicle 18 can pass, are set around the respective sections in the parking lot 7. The parking lot 7 has a plurality of groups each having a plurality of sections, and the sections are collectively disposed in each of the groups. The respective groups are disposed across the paths. The parking lot 7 has many intersections including a T-junction and a crossroads, and the paths are connected together at the respective intersections.

At least two guide routes to the target position can be set in the parking lot 7 having such a configuration. The sections provided in the loading vehicle room 3, the unloading vehicle room 5, and the parking lot 7 are each a region in which one self-driving vehicle 18 can be parked.

The self-driving vehicle 18 can travel from the loading vehicle room 3 to the parking lot 7. The self-driving vehicle 18 can further travel from the parking lot 7 to the unloading vehicle room 5.

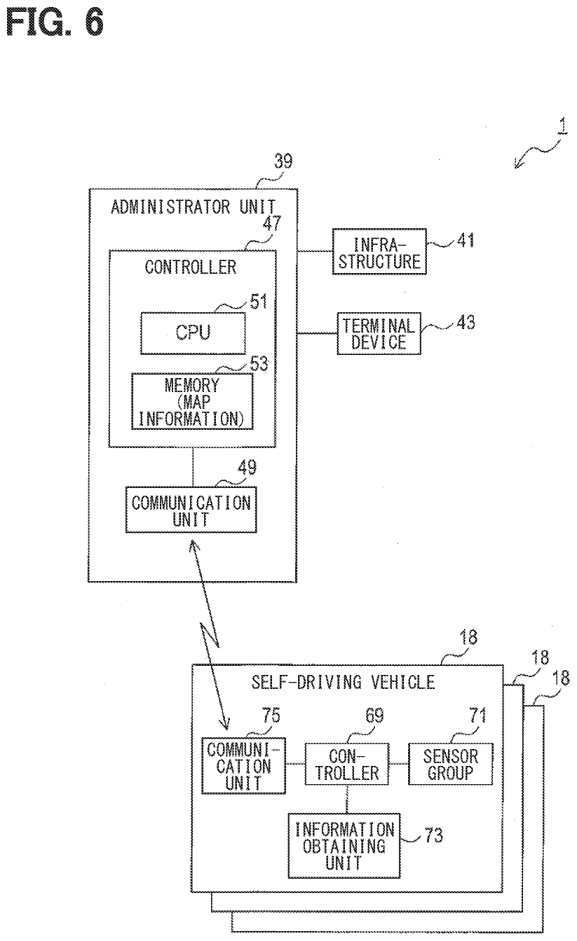

As illustrated in FIG. 6, the parking assist system 1 includes the administrator unit 39, the infrastructure 41, and the terminal device 43.

The administrator unit 39 includes a controller 47 and a communication unit 49. The controller 47 includes a microcomputer having CPU 51 and a semiconductor memory such as RAM or ROM (hereinafter, referred to as memory 53).

Each function of the controller 47 is implemented by executing by the CPU 51 a program stored in a non-transitory tangible storage medium. In this example, the memory 53 corresponds to the non-transitory tangible storage medium storing the program. A method corresponding to the program is executed through execution of the program. The controller 47 may include one or more microcomputers.

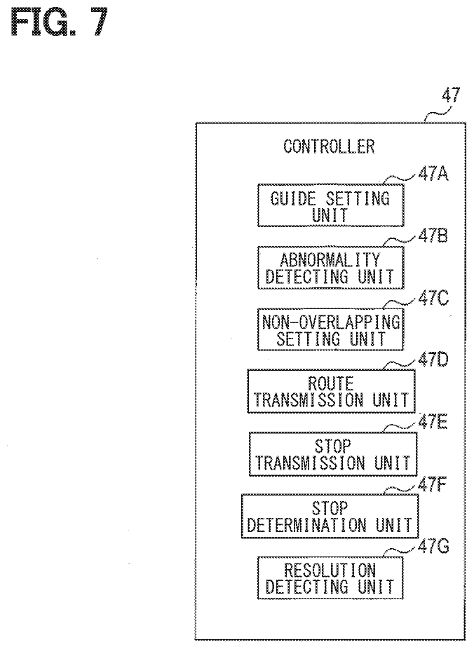

The controller 47 has a configuration for transmitting the guide route to the target position to the self-driving vehicle 18. For example, as illustrated in FIG. 7, the controller 47 includes a guide setting unit 47A, an abnormality detecting unit 47B, a non-overlapping setting unit 47C, a route transmission unit 47D, a stop transmission unit 47E, a stop determination unit 47F, and a resolution detecting unit 47G. Operations of the respective parts 47A to 47G configuring the controller 47 are described later.

The memory 53 stores map information of the relevant parking lot. The map information contains information indicating a state of each section of the parking lot 7. The state of the section includes a state where the section is empty (hereinafter, referred to as empty state) and a state where the section is occupied by the self-driving vehicle 18 (hereinafter, referred to as occupied state). The communication unit 49 can communicate with the self-driving vehicle 18.

The infrastructure 41 includes a component that obtains information indicating an inside situation of the parking assist system 1 (hereinafter, referred to as parking-lot inside information) and supplies the parking-lot inside information to the administrator unit 39. The infrastructure 41 includes a camera to photograph the inside of the parking assist system 1 and a lidar.

The parking-lot inside information includes, for example, information indicating a position of an obstacle, information indicating a state of a section in the parking lot 7, and positional information of the self-driving vehicle 18 existing within the parking assist system 1.

As illustrated in FIG. 5, the terminal device 43 is placed near the loading vehicle room 3. The terminal device 43 receives input operation by a user. The terminal device 43 outputs a signal corresponding to the input operation to the administrator unit 39.

The terminal device 43 outputs a parking request signal in response to input operation, which represents an intention of loading of the self-driving vehicle 18, for example, a parking request, by a user. The parking request signal requests that the self-driving vehicle 18 in the loading vehicle room 3 is carried into the parking lot 7 and parked therein. The terminal device 43 outputs, for example, identification information of the self-driving vehicle 18 when outputting the signal corresponding to the input operation to the administrator unit 39.

The terminal device 43 outputs an unloading request signal in response to input operation, which represents an intention of unloading of the self-driving vehicle 18, for example, an unloading request, by a user. The unloading request signal requests that the self-driving vehicle 18 parked in the parking lot 7 is carried into the unloading vehicle room 5.

For example, the terminal device 43 outputs identification information of the self-driving vehicle 18 in response to the input operation. The identification information is, for example, information of a license plate to uniquely identify the self-driving vehicle 18.

After outputting the parking request signal, the terminal device 43 can receive input operation representing an intention of unloading before the self-driving vehicle 18 reaches the parking lot 7. After outputting the unloading request signal, the terminal device 43 can receive input operation representing an intention of loading before the self-driving vehicle 18 reaches the unloading vehicle room 5.

As described before, the self-driving vehicle 18 has the automated valet parking function. As illustrated in FIG. 6, a plurality of self-driving vehicles 18 each include a controller 69, sensor group 71, and a positional information obtaining unit 73, and a communication unit 75. The controller 69 controls each of the parts of the self-driving vehicle 18. A function of automated driving is implemented by control performed by the controller 69. The self-driving vehicle 18 obtains map information and guide routes of the relevant parking lot from the administrator unit 39, and uses such map information and guide routes in automated driving.

The sensor group 71 obtains peripheral information indicating a situation of the periphery of the self-driving vehicle 18. The content of the peripheral information includes, for example, a position of an obstacle existing in the periphery of the self-driving vehicle 18. The sensor group 71 includes, for example, a camera and a lidar. The self-driving vehicle 18 uses the peripheral information in automated driving.

The positional information obtaining unit 73 obtains positional information of the self-driving vehicle 18. The positional information obtaining unit 73 is, for example, a positional information estimation system with a lidar and a map. The self-driving vehicle 18 uses the positional information in automated driving. The communication unit 75 can communicate with the administrator unit 39.

### 2-2 Processing

### 2-2-1 Parking Setting Processing Performed by Administrator Unit 39

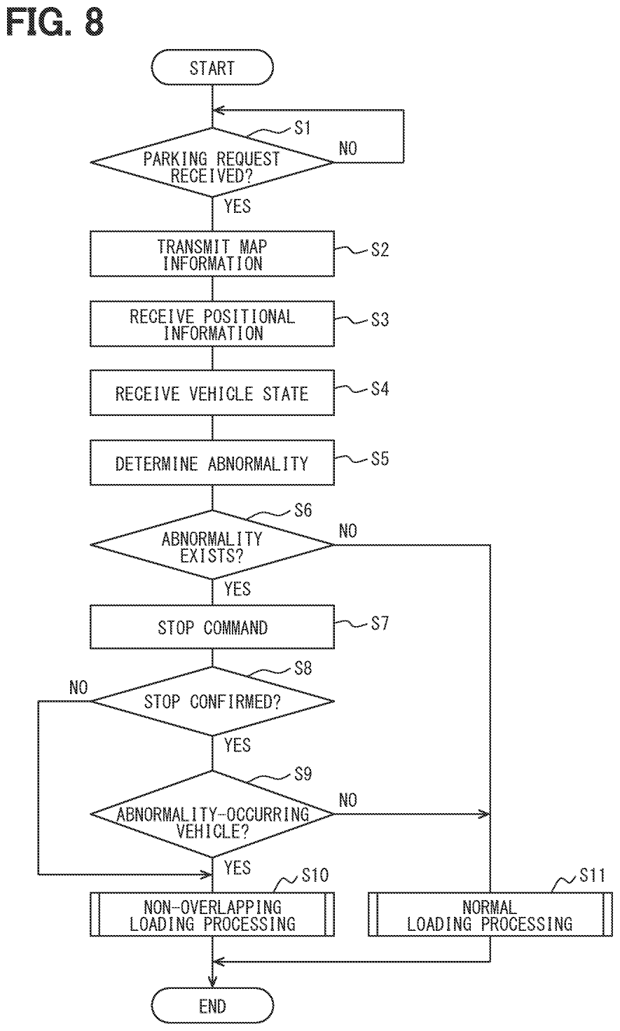

Parking setting processing performed by the administrator unit 39 is described with reference to FIG. 8. The parking setting processing starts, for example, upon power-on of the administrator unit 39, and repeatedly performed thereafter. The processes of S2 and subsequent steps of this processing are performed for each of the self-driving vehicles 18 that has requested parking.

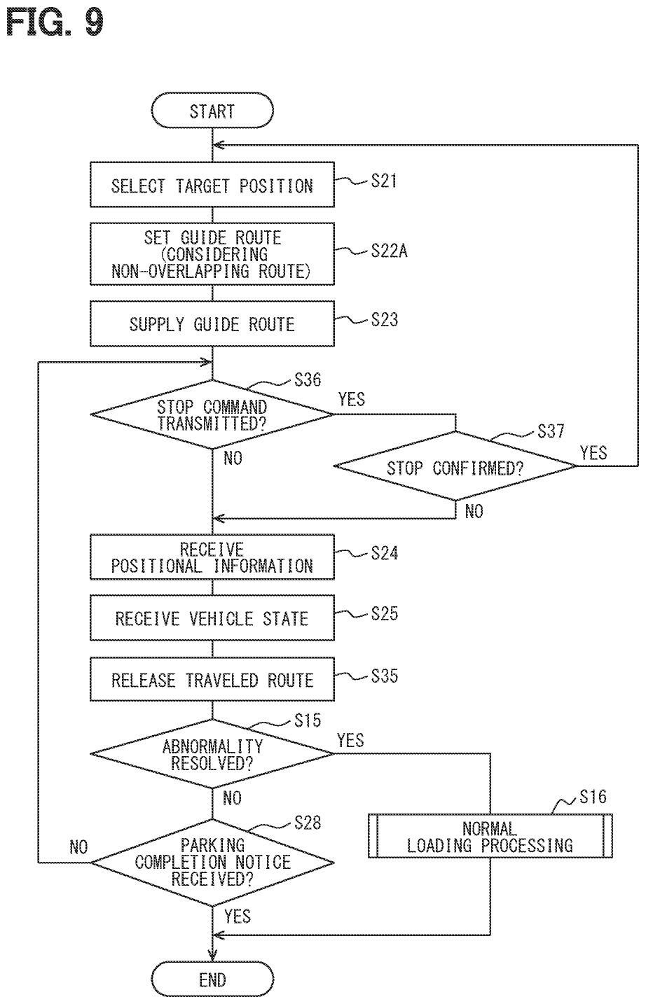

The guide setting unit 47A of the administrator unit 39 determines whether the parking request signal is received at step (hereinafter, abbreviated as “S”) 1 of the parking setting processing of FIG. 9. If no parking request signal is received, this processing repeats S1. If the parking request signal is received, this processing is passed to S2.

In this case, when a user such as an occupant of the self-driving vehicle 18 inputs the parking request through operation of the terminal device 43, the terminal device 43 transmits a parking request signal corresponding to the input to the administrator unit 39. At this time, the user inputs, to the terminal device 43, vehicle information such as a license plate to identify the vehicle, user information such as user ID or a password to identify the user, and other necessary information.

When the terminal device 43 is operated, some pieces of Information, including unique information such as identification ID for specifying that terminal device 43, vehicle information, and user information, are transmitted to the administrator unit 39. After operating the parking request, the user can go to the destination away from the relevant parking lot.

Subsequently, the guide setting unit 47A transmits the map information of the relevant parking lot to the self-driving vehicle 18 in S2. Specifically, when the user performs input operation to start parking with the terminal device 43, the guide setting unit 47A transmits the map information of the relevant parking lot to the self-driving vehicle 18.

The self-driving vehicle 18 receiving the map information is set to return positional information and a vehicle state as described later. Thus, the guide setting unit 47A receives the positional information transmitted from the self-driving vehicle 18 at S3. The processing then proceeds to S4, in which the abnormality detecting unit 47B of the administrator unit 39 receives the vehicle state transmitted from the self-driving vehicle 18.

The vehicle state refers to a state of the self-driving vehicle 18. More in detail, the vehicle state refers to failure diagnosis results of the self-driving vehicle 18, and data by which abnormality can be diagnosed, such as sensor values of air pressure, cooling water temperature, residual fuel, and vehicle speed of the self-driving vehicle 18.

Subsequently, the abnormality detecting unit 47B performs abnormality determination based on, for example, the vehicle state in S5. For example, the abnormality detecting unit 47B compares the vehicle state to a predetermined reference value or reference range, and determines the self-driving vehicle 18 to be abnormal when the vehicle state is greater than the reference value as an upper limit value, lower than the reference value as a lower limit value, or out of the reference range.

The abnormality detecting unit 47B also determines the self-driving vehicle 18 to be abnormal in case of receiving a failure diagnosis result indicating that the self-driving vehicle 18 is broken down. Further, the abnormality detecting unit 47B also determines the self-driving vehicle 18 to be abnormal when being failed to receive positional information or a vehicle state of the self-driving vehicle 18 for a predetermined time or longer.

When delay occurs in communication, or when communication with a plurality of self-driving vehicles 18 is interrupted, the abnormality detecting unit 47B determines that abnormality exists in the entire parking assist system 1, i.e., in all the self-driving vehicles 18. The delay in communication can be determined, for example, by whether a time difference between a timing at which the positional information or the vehicle state is detected by the self-driving vehicle 18 and a timing at which the positional information or the vehicle state is recognized by the administrator unit 39 exceeds a predetermined delay determination time. When abnormality exists, the abnormality detecting unit 47B stores, in the memory 53, information that indicates the abnormality and specifies the abnormal self-driving vehicle 18. The abnormal self-driving vehicle 18 corresponds to the particular vehicle of this disclosure, and may be mentioned as abnormality-occurring vehicle hereinafter.

While performing automated driving along a guide route generated by the administrator unit 39, the self-driving vehicle 18 periodically transmits to the administrator unit 39 an estimation result of current location as the positional information of the self-driving vehicle 18. Further, the self-driving vehicle 18 periodically transmits information on the vehicle state (which may be hereinafter referred to as vehicle state information) obtained from the sensor group 71 to the administrator unit 39.

When receiving no positional information or no vehicle state information from the self-driving vehicle 18 performing automated driving in the relevant parking lot for a predetermined time or longer (for example, five seconds or more), the abnormality detecting unit 47B may determine that communication with that self-driving vehicle 18 is delayed or interrupted. When the administrator unit 39 receives no positional information and no vehicle state information of a plurality of self-driving vehicles 18 performing automated driving for a predetermined time or longer, the abnormality detecting unit 47B may determine that abnormality affecting the entire parking assist system 1 occurs.

The communication delay and the communication interruption may each be referred to as communication trouble. When the administrator unit 39 receives no positional information and no vehicle state information of a plurality of self-driving vehicles 18 performing automated driving for a predetermined time or longer, the abnormality detecting unit 47B may determine that some trouble occurs in communication with all the self-driving vehicles 18.

Subsequently, the abnormality detecting unit 47B determines whether abnormality exists at S6. At this time, the abnormality detecting unit 47B obtains information indicating that abnormality occurs from the memory 53 of the controller 47 and performs determination. If abnormality exists, the processing proceeds to S7, and the stop transmission unit 47E of the administrator unit 39 transmits a stop command to all the self-driving vehicles 18 in the relevant parking lot.

The stop command is transmitted regardless of whether the self-driving vehicle 18 is traveling. The stop command is transmitted not only to the self-driving vehicle 18 to be subjected to parking setting processing but also to the self-driving vehicle 18 to be subjected to unloading setting processing as described later.

Subsequently, the stop determination unit 47F of the administrator unit 39 determines whether stop confirmation is succeeded within a predetermined time after transmission of the stop command in S8. The stop confirmation means confirming vehicle speed of zero.

If the stop confirmation is not succeeded, this processing is passed to S10. If the stop confirmation is succeeded, the abnormality detecting unit 47B determines whether the relevant self-driving vehicle 18 is an abnormality-occurring vehicle with abnormality at S9. Whether the self-driving vehicle 18 is the abnormality-occurring vehicle can be determined by referring to the memory 53.

If the self-driving vehicle 18 is the abnormality-occurring vehicle, the controller 47 performs non-overlapping loading processing at S10. In the non-overlapping loading processing, guide routes are generated for the remaining self-driving vehicles 18 so as not to overlap the non-overlapping route for the abnormality-occurring vehicle 18, and the remaining self-driving vehicle 18 are moved to a parking position along the guide routes.

Here, “non-overlapping” means that a plurality of guide routes do not cross or contact each other. The non-overlapping route is set in order to avoid contact between a plurality of self-driving vehicles 18. Hence, if a plurality of self-driving vehicles 18 may come into contact with each other in consideration of, for example, vehicle width of each of the self-driving vehicles 18 while the guide routes have no contact with each other, the controller 47 determines that the guide routes have contact with each other. When the non-overlapping loading processing ends the controller 47 terminates the parking setting processing. When the self-driving vehicle 18 is not the abnormality-occurring vehicle, this processing proceeds to S11.

On the other hand, if no abnormality exists in S6, the processing is passed to S11, and the controller 47 performs normal loading processing in S11. In the normal loading processing, a guide route is generated so as not to overlap the non-overlapping route but so as to be allowed to overlap other guide routes other than the non-overlapping route, and the self-driving vehicles 18 are moved to a parking position along the guide routes. When the normal loading processing is ended, the controller 47 ends the parking setting processing.

The non-overlapping routes are individually set in the above-described parking setting processing and in unloading setting processing as described later, and have influence on each other. Specifically, another guide route is set to avoid the non-overlapping route set in the unloading setting processing in case of the parking setting processing, and another guide route is set to avoid the non-overlapping route set in the parking setting processing in case of the unloading setting processing.

### 2-2-2. Non-Overlapping Loading Processing

Next, the non-overlapping loading processing performed by the administrator unit 39 is described with reference to FIG. 9. In the non-overlapping loading processing, first, the guide setting unit 47A of the administrator unit 39 selects a target position, a parking position in this case, at S21.

An empty section in the parking lot 7 is selected as the parking position. The guide setting unit 47A determines a state of each section in the following manner, for example. In parking in a particular section, the self-driving vehicle 18 sends identification information of the section and information of parking start to the administrator unit 39. When going out of a section in which the self-driving vehicle 18 has previously parked, the self-driving vehicle 18 sends identification information of that section and information of parking end to the administrator unit 39.

The guide setting unit 47A determines a state of each section based on a history of the information sent from the self-driving vehicle 18. Further, the guide setting unit 47A may determine a state of each section based on information supplied from the infrastructure 41.

When only one empty section exists, the guide setting unit 47A defines the section as the parking position. When a plurality of empty sections exist, the guide setting unit 47A selects one section as the parking position from among the empty sections according to a predetermined criterion. Examples of the criterion include a criterion of selecting a section nearest the loading vehicle room 3, a criterion of selecting a section nearest the unloading vehicle room 5, and a criterion of selecting a section in an area in which the empty sections are gathered.

At S22A, the guide setting unit 47A sets a guide route using the map information of the relevant parking lot. In this case, the guide setting unit 47A sets a guide route for self-running of the self-driving vehicle 18 from current location of the self-driving vehicle 18 to the parking position selected at S21 as described above.

However, when a guide route for the self-driving vehicle 18 is already set, that guide route may be directly used. This is because a plurality of self-driving vehicles 18 are intentionally moved more safely when no guide route can be changed due to, for example, interruption of communication with the relevant self-driving vehicles 18.

When a guide route for the relevant self-driving vehicle 18 is not set but a non-overlapping route already exists in guide routes for other self-driving vehicles 18, the non-overlapping setting unit 47C of the administrator unit 39 sets the guide route for the self-driving vehicle 18 to avoid the non-overlapping route. In this embodiment, the guide setting unit 47A sets the guide route without considering guide routes that are not the non-overlapping route.

This is because another self-driving vehicle 18 sets a guide route so as to avoid the non-overlapping route set for the relevant self-driving vehicle 18, and as a result a guide route for the relevant self-driving vehicle 18 is set so as not to overlap the guide route for another self-driving vehicle 18. That is, the guide route in this case is set as the non-overlapping route to avoid overlapping with the guide routes for other self-driving vehicles 18.

Whether each path (for example, each link as described later) is available as the guide route is included in the map information of the relevant parking lot stored in the memory 53. When a plurality of lanes exist in a path, whether each lane is available as the guide route may be included in the map information.

A path set as the non-overlapping route is set as an unavailable path, and set as an available path when abnormality is resolved, or when the self-driving vehicle 18 finishes travelling along the non-overlapping route and thus the relevant path is released.

Subsequently, at S23, the guide setting unit 47A transmits information (hereinafter, referred to as guide route information) indicating the guide route set in S22A using the communication unit 49. As described later, the self-driving vehicle 18 receives the guide route information and starts automated driving along the guide route upon receiving such information.

Subsequently, at S36, the stop determination unit 47F determines whether a stop command is transmitted. The stop command in this case is based on abnormality in another self-driving vehicle 18 or abnormality in the parking assist system 1. If the stop command is not transmitted, the processing proceeds to S24. If the stop command is transmitted, the processing proceeds to S37, and the stop determination unit 47F determines whether stop confirmation is successfully done within a predetermined time after transmission of the stop command. This process is the same as that of S8.

If the stop confirmation is succeeded, this processing returns to S21. If the stop confirmation is not successfully done, the resolution detecting unit 47G of the administrator unit 39 obtains positional information of the self-driving vehicle 18 in S24. Subsequently, the resolution detecting unit 47G receives vehicle information in S25. At this time, if the self-driving vehicle 18 has transitioned to a non-abnormal state, description on the relevant self-driving vehicle 18 is deleted from the memory 53. The processes of S24 and S25 are the same as those of the above-described S3 and S4, respectively.

Subsequently, the guide setting unit 47A releases the traveled route in S35. Specifically, the guide setting unit 47A specifies a portion, which has been traveled by the self-driving vehicle 18, of the path set as the non-overlapping route in the relevant parking lot from the current location of the self-driving vehicle 18, and removes the portion from the non-overlapping route. More in detail, the guide setting unit 47A changes setting of the portion, which has been traveled by the self-driving vehicle 18, of the path that has been set as unavailable in the map information, to available. As a result, the portion traveled by the self-driving vehicle 18 is now not the non-overlapping route, and thus can be used as a guide route for another self-driving vehicle 18.

Subsequently, in S15, the resolution detecting unit 47G of the administrator unit 39 determines whether abnormality is resolved. Resolution of abnormality means that the relevant self-driving vehicle 18 or the parking assist system 1 has transitioned from an abnormal state to a non-abnormal state. The resolution detecting unit 47G refers to the memory 53, and if the self-driving vehicle 18 is not now the abnormality-occurring vehicle, determines that abnormality is resolved.

If abnormality is resolved, this processing proceeds to S16, and the normal loading processing is performed at S16. Subsequently, this processing ends. If abnormality is not resolved, whether the communication unit 49 receives a parking completion notice is determined at S28.

The parking completion notice is transmitted by the self-driving vehicle 18 when the self-driving vehicle 18 is parked at the target position, a parking position in this case, as an endpoint of the guide route. If the communication unit 49 receives the parking completion notice, the guide setting unit 47A ends this processing. If the communication unit 49 does not receive the parking completion notice, the processing returns to S36.

### 2-2-3. Normal Loading Processing

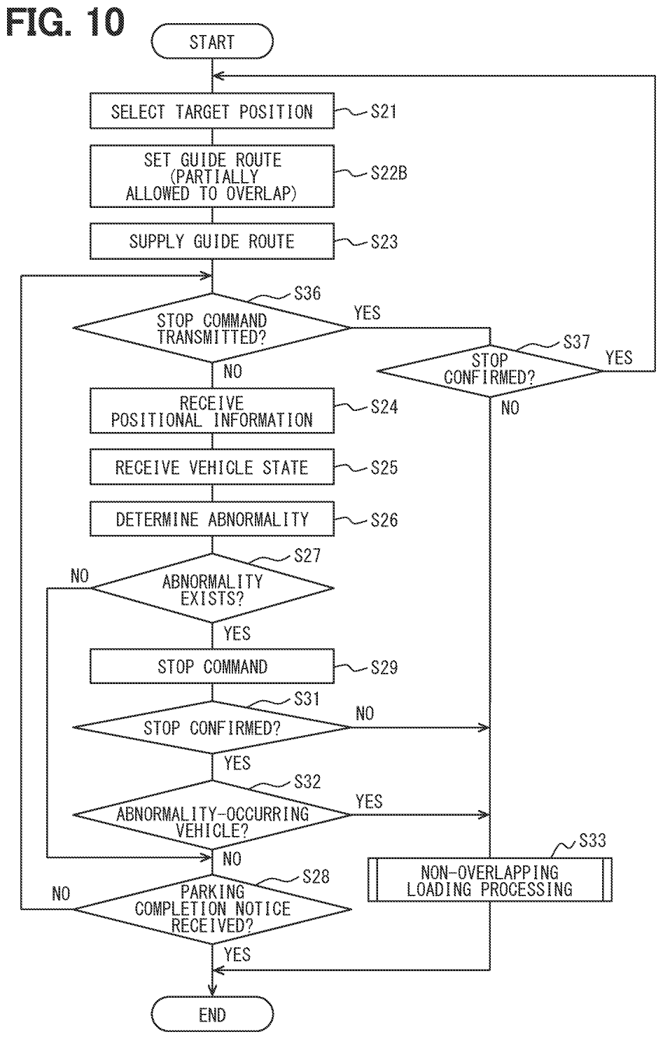

The normal loading processing performed by the administrator unit 39 is described with reference to FIG. 10. In the normal loading processing, as with the non-overlapping loading processing, processes of S21, S23, and S36 to S37 are performed. At S22B of the normal loading processing, the non-overlapping setting unit 47C of the administrator unit 39 sets a guide route only using a path set as available in the map information of the parking lot without using a path set as the non-overlapping route.

When non-overlapping loading processing or non-overlapping unloading processing is performed for another self-driving vehicle 18, the non-overlapping setting unit 47C of the administrator unit 39 waits setting of the non-overlapping route and then performs the process of S22B. When no non-overlapping route exists, or when abnormality is resolved, the guide setting unit 47A sets guide routes for a plurality of self-driving vehicles 18 so as to be allowed to overlap with each other.

For example, when a non-overlapping route is set as illustrated in A1 of FIG. 5, the guide routes shown in B1 and B2 cannot be set under this processing. In such a case, setting of B1 and B2 is suspended until the non-overlapping route A1 is released. Alternatively, respective guide routes to points P1 and P2 before the overlapped points are generated so as not to overlap with the non-overlapping route A1, and guiding is started along the guide routes B1 and B2.

If the stop confirmation is succeeded in S37, this processing is returned to S21. If the stop confirmation is not succeeded, this processing is passed to S33.

If no stop command is transmitted in S36, the controller 47 performs the processes of S24 and S25 as described before. Subsequently, the abnormality detecting unit 47B performs abnormality determination based on the vehicle state at S26. Subsequently, the abnormality detecting unit 47B determines whether abnormality exists at S27. The processes of S26 and S27 are the same as those of the above-described S5 and S6, respectively.

If no abnormality exists, the processing is passed to the above-described S28. If abnormality exists, the processing is passed to S29, and the stop transmission unit 47E of the administrator unit 39 transmits a stop command to all the self-driving vehicles 18. The stop command is transmitted regardless of whether the self-driving vehicle 18 is traveling.

Subsequently, the stop determination unit 47F determines whether stop confirmation is successfully done within a predetermined time after transmission of the stop command in S31.

If the stop confirmation is not succeeded, this processing is passed to S33. If the stop confirmation is succeeded, the abnormality detecting unit 47B determines whether the self-driving vehicle 18 is the abnormality-occurring vehicle at S32.

If the relevant self-driving vehicle 18 is not the abnormality-occurring vehicle, this processing is passed to the above-described S28. If the relevant self-driving vehicle 18 is the abnormality-occurring vehicle, the controller 47 performs the non-overlapping loading processing at S33. After performing the non-overlapping loading processing, the normal loading processing is ended.

### 2-2-4. Auto-Parking Processing Performed by Self-Driving Vehicle 18

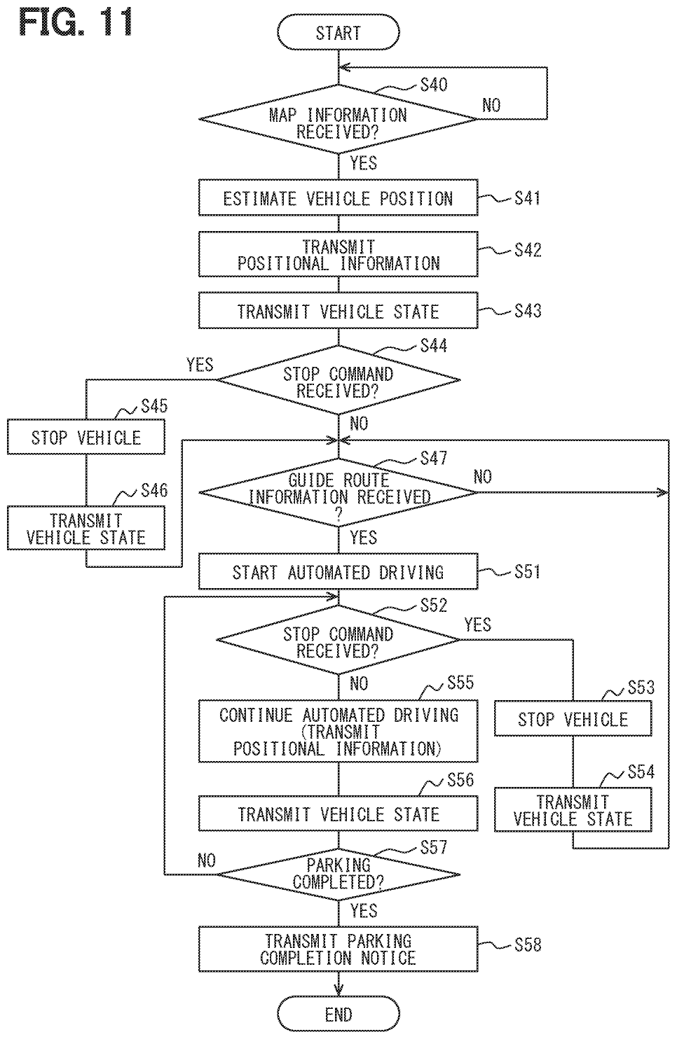

Auto-parking processing performed by the self-driving vehicle 18 is described with reference to FIG. 11. In the auto-parking processing, the self-driving vehicle 18 performs automated driving from the loading vehicle room 3 to the parking position in accordance with the parking setting processing performed by the administrator unit 39.

The controller 69 determines whether the communication unit 75 receives the map information of the parking lot in S40. If the communication unit 75 does not receive the map information, the processing returns to S40.

If the communication unit 75 receives the map information, the processing is passed to S41, and the controller 69 estimates current location of the self-driving vehicle 18. The controller 69 transmits an estimation result of the current location as positional information of the self-driving vehicle 18 to the administrator unit 39 in S42.

Subsequently, the controller 69 obtains a vehicle state from the sensor group 71 and transmits the vehicle state to the administrator unit 39 in S43. The vehicle state is as described above.

Subsequently, the controller 69 determines whether the stop command is received in S44. If the stop command is received, the procedure proceeds to S45, and the controller 69 stops the relevant self-driving vehicle 18. Subsequently, the controller 69 obtains a vehicle state from the sensor group 71 and transmits the vehicle state to the administrator unit 39 again in S46. Subsequently, this processing is passed to S47.

If the stop command is not received in S44, the controller 69 determines whether the guide route information is received in S47. If the guide route information is not received in S47, the processing is returned to S47.

If the guide route information is received, the controller 69 starts automated driving of the self-driving vehicle 18 in S51. At the automated driving, the controller 69 allows the self-driving vehicle 18 to travel according to a guide route contained in the guide route information.

Subsequently, the controller 69 determines whether the stop command is received at S52. If the stop command is received, the processing proceeds to S53, and the controller 69 stops the relevant self-driving vehicle 18. Subsequently, the controller 69 obtains a vehicle state from the sensor group 71 and transmits the vehicle state to the administrator unit 39 again in S54. Subsequently, this processing is returned to S47.

If the stop command is not received in S52, the controller 69 continues automated driving of the self-driving vehicle 18 in S55. At this time, the controller 69 repeatedly transmits the positional information of the self-driving vehicle 18 to the administrator unit 39 until completion of parking is determined at S57 as described later. In addition, the controller 69 repeatedly transmits the vehicle state to the administrator unit 39 at S56. The transmitted positional information and vehicle state are received by the administrator unit 39.

Subsequently, the controller 69 determines whether parking is completed in S57. The completion of parking means that the self-driving vehicle 18 arrives the parking position set by the administrator unit 39. If parking is not completed, the processing is returned to S52.

When parking is completed, the processing is passed to S58, and the controller 69 transmits a parking completion notice using the communication unit 75 and ends this processing. The administrator unit 39 receives the transmitted parking completion notice.

### 2-2-5 Unloading Setting Processing Performed by Administrator Unit 39

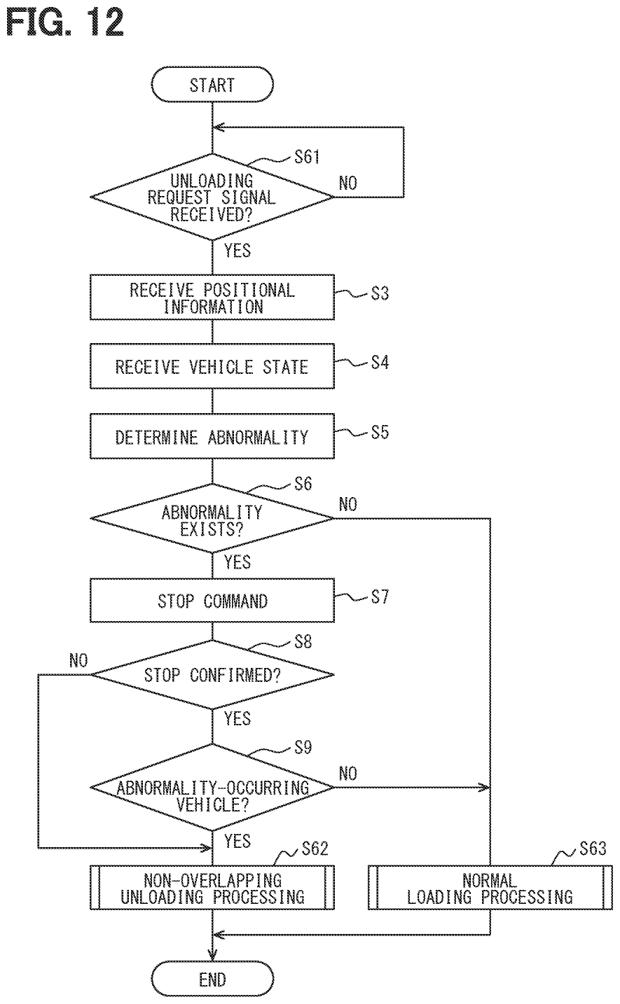

Unloading setting processing performed by the administrator unit 39 is described with reference to FIG. 12. In the unloading setting processing, the self-driving vehicle 18 is moved from a parking position to the unloading vehicle room 5 by self-running of the self-driving vehicle 18. The processes of S3 and subsequent steps of this processing are performed for each self-driving vehicle 18 that has requested unloading.

The unloading setting processing is repeatedly performed in parallel with another processing by the controller 47 of the administrator unit 39. In the unloading setting processing, first, the guide setting unit 47A determines whether the unloading request signal is received at S61. The unloading request signal indicates a request of moving the self-driving vehicle 18 from the parking position to the unloading vehicle room 5. When a user operates the terminal device 43 to input an unloading request, the terminal device 43 transmits the unloading request signal to the administrator unit 39.

If no unloading request signal is received, this processing repeats S61. If the unloading request signal is received, the processes of S3 to S9 are performed. If no abnormality exists at S6, this processing is passed to S63, and normal loading processing is performed. In the normal loading processing, a guide route is generated so as to be allowed to overlap with a guide route other than the non-overlapping route without overlapping with the non-overlapping route, and the self-driving vehicle 18 is moved to the unloading vehicle room 5 along the guide route. When the normal unloading processing is ended, the administrator unit 39 ends the parking setting processing.

If stop confirmation is not successfully done at S8, or if the relevant self-driving vehicle 18 is the abnormality-occurring vehicle at S9, this processing is passed to S62, and the non-overlapping unloading processing is performed. In the non-overlapping unloading processing, a non-overlapping route is generated so as not to overlap a guide route for another self-driving vehicle 18, and the relevant self-driving vehicle 18 is moved to the unloading vehicle room 5 along the non-overlapping route. When the non-overlapping unloading processing is ended, the administrator unit 39 ends the unloading setting processing.

### 2-2-6. Non-Overlapping Unloading Processing

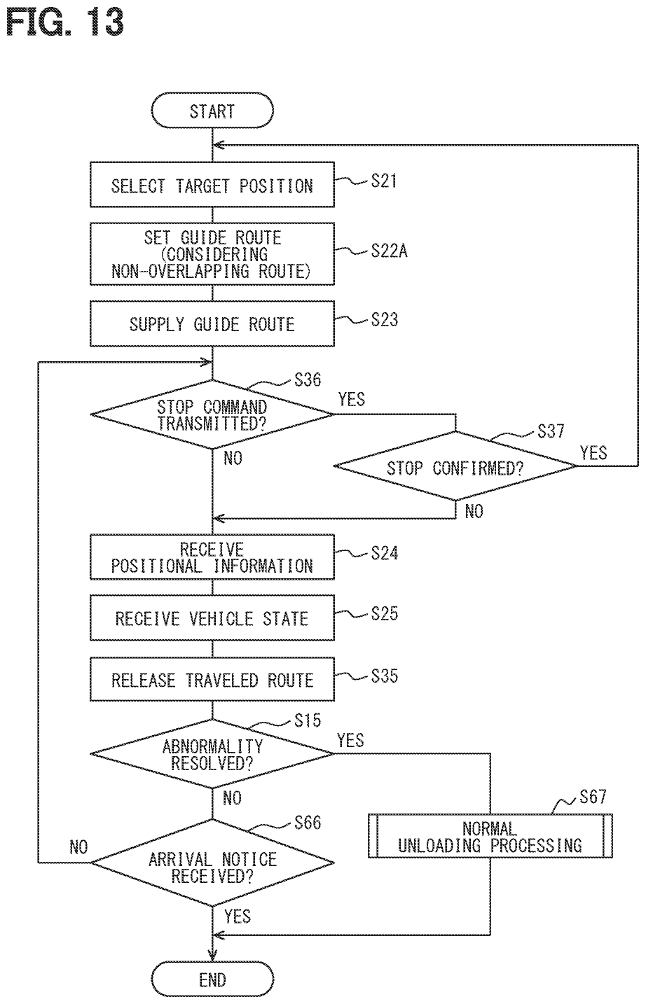

The non-overlapping unloading processing performed by the administrator unit 39 is described with reference to FIG. 13. As illustrated in FIG. 13, S21 to S25, S35 to S37, and S15 in the non-overlapping loading processing (FIG. 9) as described before are performed in the non-overlapping unloading processing. However, the guide setting unit 47A selects one section in the unloading vehicle room 5 as the target position in S21.

If abnormality is resolved at S15, the controller 47 performs normal unloading processing at S67. Subsequently, this processing is ended. If abnormality is not resolved at S15, the guide setting unit 47A determines whether an unloading completion notice is received in S66. The unloading completion notice is transmitted from the self-driving vehicle 18 when the self-driving vehicle 18 reaches the unloading vehicle room 5 as the target position by self-running.

The guide setting unit 47A returns the processing to the process of S36 if the unloading completion notice is not received, and ends this processing if the unloading completion notice is received.

### 2-2-7. Normal Unloading Processing

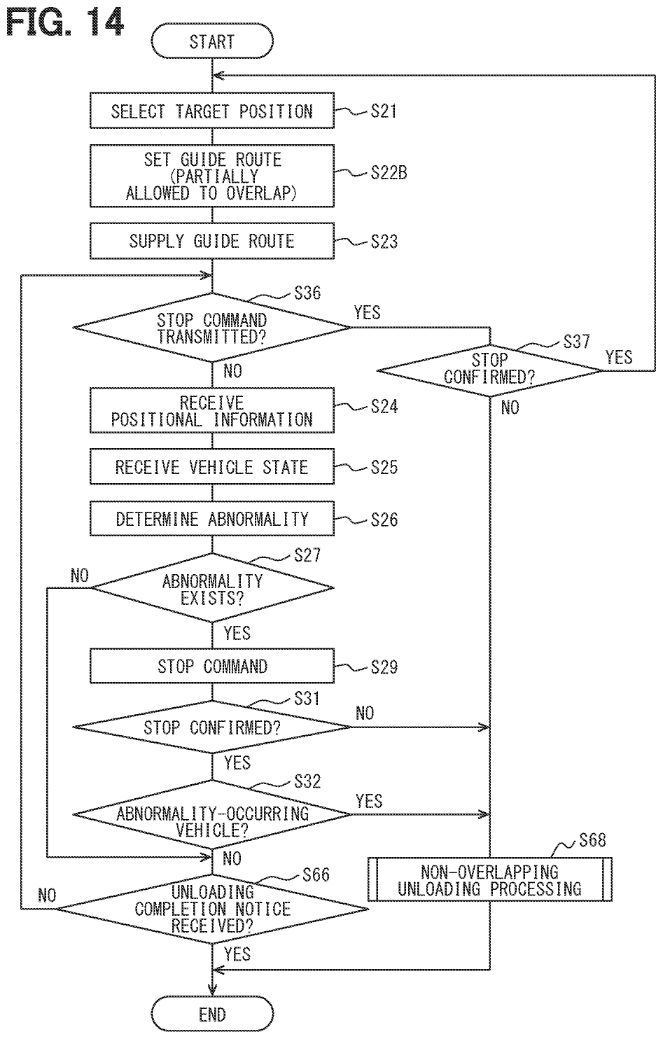

The normal unloading processing performed by the administrator unit 39 is described with reference to FIG. 14. As illustrated in FIGS. 14, S21 to S27, S29, S31 to S32, and S36 to S37 in the normal loading processing (FIG. 10) are performed in the normal unloading processing. S66 is performed as with FIG. 13. In the normal unloading processing, the non-overlapping unloading processing is performed in S68 in place of the non-overlapping loading processing of S33. Subsequently, this processing is ended.

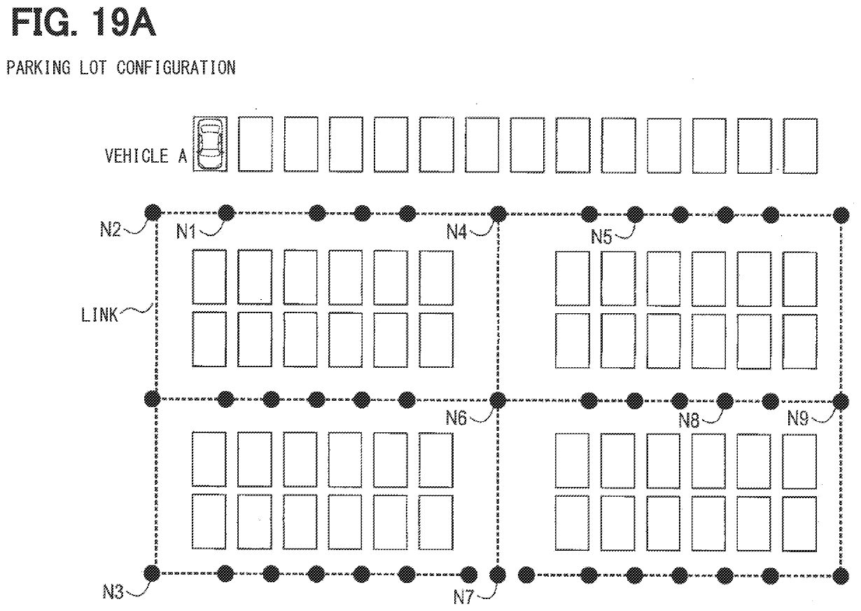

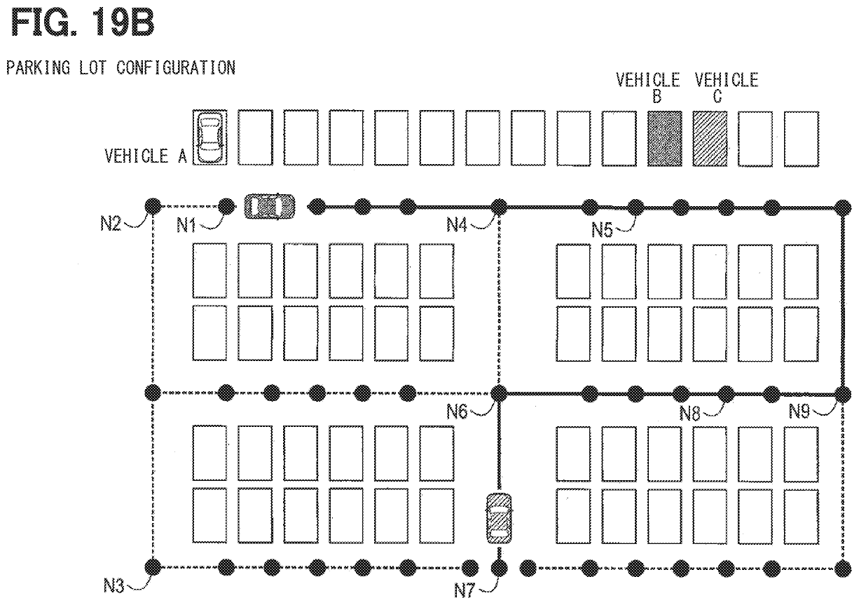

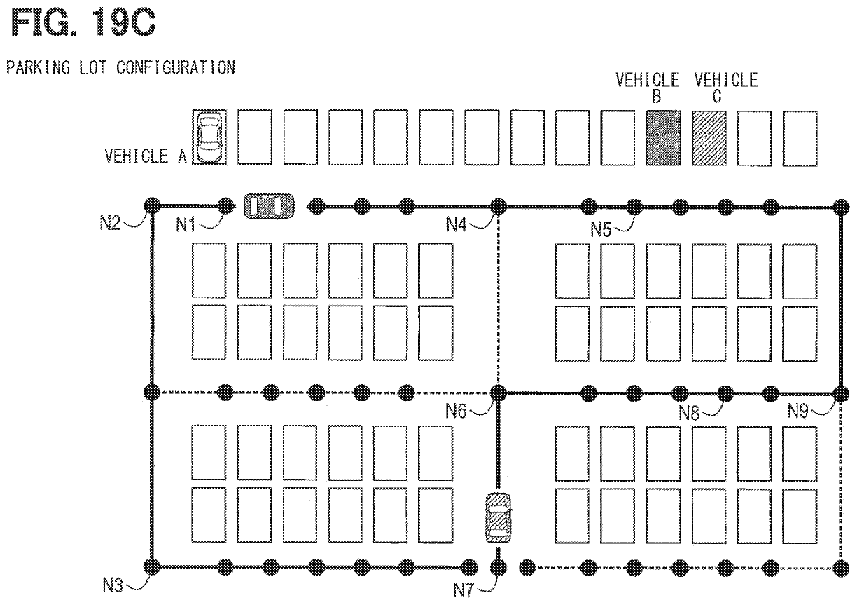

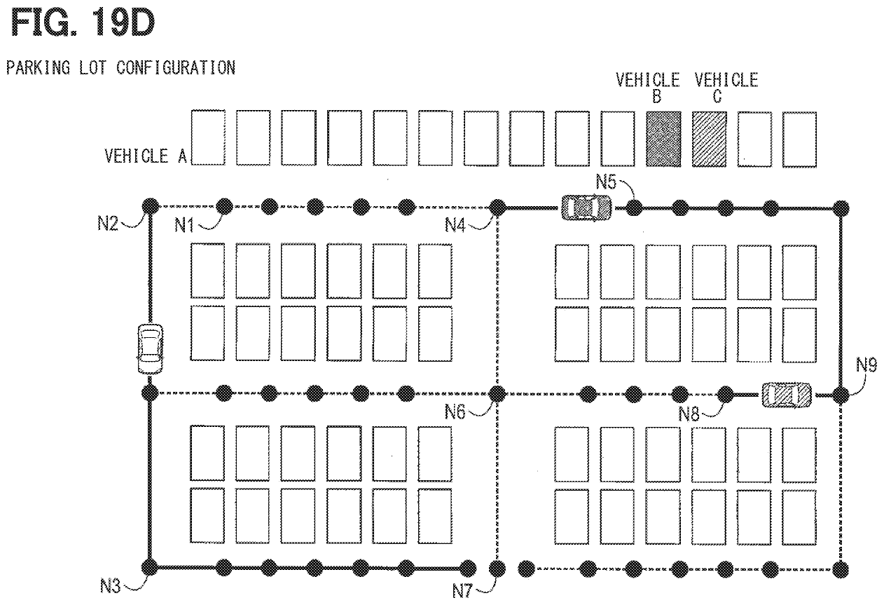

Setting of availability or unavailability of a route, setting of a guide route, and release of a traveled route performed by the guide setting unit 47A are described with reference to FIG. 19A to FIG. 19D. FIG. 19A to FIG. 19D each conceptually illustrate whether each path in the parking lot is available. The path in the parking lot is configured of nodes and links. In FIG. 19A to FIG. 19D, nodes N1 to N9 are shown for convenience.

In FIG. 19A to FIG. 19D, a vehicle A is an self-driving vehicle 18 that moves from the loading vehicle room 3 to the target parking position. A vehicle B is an self-driving vehicle 18 that moves from a predetermined position in a parking space to the unloading vehicle room 5 according to the non-overlapping unloading processing. A vehicle C is an self-driving vehicle 18 that moves from a predetermined position in the parking space to the unloading vehicle room 5 according to the non-overlapping unloading processing.

Whether each path is available as the guide route is included in the map information of the relevant parking lot stored in the memory 53. Information (which may be referred to as flag) on whether a path (which may be referred to as link) between adjacent nodes is available as a guide route is stored in the memory 53. In FIG. 19A to FIG. 19D, when a path between the nodes is set available, the path is indicated by a dot line, and when the path is unavailable, the path is indicated by a solid line. The memory 53 stores a vehicle and a guide route in association with each other.

In FIG. 19A, since no guide route is set, all paths are available.

In the situation of the parking lot of FIG. 19B, the vehicles B and C have been traveled, the vehicle A is located in the loading vehicle room 3, and a guide route for the vehicle A is not set yet. Since the vehicles B and C are subjected to the non-overlapping unloading processing, the guide routes for the vehicles B and C are set so as not to overlap each other. The guide routes for the vehicles B and C correspond to the routes B1 and C2, respectively, in FIG. 2. A path from a node N1, which corresponds to the guide route for the vehicle B and contains nodes N4 and N5, is set unavailable. A path from a node N7, which corresponds to the guide route for the vehicle C and contains nodes N8 and N9, is set unavailable.

When setting the guide route for the vehicle A, the guide setting unit 47A creates a route to reach a target position by connecting only available paths, i.e., only paths indicated by dot lines in FIG. 19B, together. For example, a guide route via nodes N2 and N3, i.e., a guide route corresponding to the route A2 in FIG. 2 is set in FIG. 19B. When the vehicle A is subjected to the normal loading processing, the paths are still set available even after the guide route for the vehicle A is set as shown in FIG. 19B. When the vehicle A is subjected to the non-overlapping loading processing, the paths contained in the relevant route is set unavailable as shown in FIG. 19C.

The guide setting unit 47A releases the traveled route in S35. Release of the traveled route is described with reference to FIG. 19D.

In FIG. 19D, the vehicles A, B, and C are each assumed to perform automated driving along the set guide route. Each vehicle repeatedly and regularly transmits positional information to the administrator unit 39 until the controller 69 determines completion of parking. Hence, the administrator unit 39 specifies a path, through which the relevant vehicle has passed, in each guide route based on the guide route set for the vehicle and current location of the vehicle. For example, the administrator unit 39 compares the current location to a node, and determines whether the vehicle has passed through the node and thus specifies a traveled portion.

The guide setting unit 47A specifies a path through which a vehicle has passed for each vehicle, and selects a path, along which a vehicle has traveled, among paths that have been set unavailable in the map information in the memory 53 and changes the path to be available.

In FIG. 19D, the vehicle B has moved to between the nodes N4 and N5, and a path from the node N1 to the node N4 is changed to be available. The vehicle C has moved to between the nodes N8 and N9 while being located between the nodes N6 and N7 in FIG. 19B. A path from the node N7 to the node N8 is changed to be available due to such movement of the vehicle C. In FIG. 19D, the vehicle A is assumed to be subjected to the normal loading processing.

In FIGS. 19A to 19D, the nodes are assumed to exist in correspondence to each parking frame. However, a method for mapping whether each path is available as the guide route is not limited to this. The inside of the parking lot may be divided into a plurality of areas to set whether each area is available. A path may be divided into predetermined distances to set whether each distance is available.

### 2-2-8. Automated Unloading Processing Performed by Self-Driving Vehicle 18

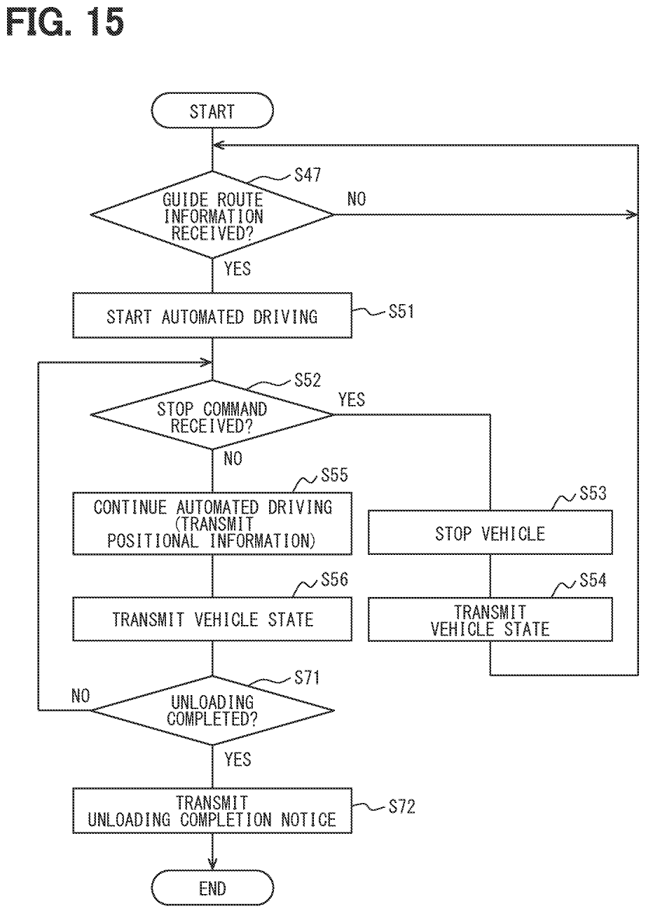

Automated unloading processing performed by the self-driving vehicle 18 is described with reference to FIG. 15. In the automated unloading processing, the self-driving vehicle 18 is allowed to travel from the parking position to the unloading vehicle room 5 in accordance with the unloading setting processing performed by the administrator unit 39.

As illustrated in FIG. 15, the processes of S47 and S51 to S56 in the above-described automated unloading processing are performed in the non-overlapping unloading processing. After S56, the controller 69 determines whether unloading is completed in S71. When detecting that the self-driving vehicle 18 reaches the unloading vehicle room 5 as the target position, the controller 69 determines that unloading is completed.

If unloading is not completed, the processing is returned to S52. If unloading is completed, the controller 69 transmits an unloading completion notice to the administrator unit 39 and ends the non-overlapping unloading processing in S72.

### 2-3. Advantageous Effects

According to the embodiment as described in detail above, the following advantageous effects are exhibited.

(2a) One aspect of the disclosure is the administrator unit 39 configured to support parking of a vehicle. A plurality of vehicles, which each are configured to enable automated driving according to a guide route set by the administrator unit 39 in a parking lot, are assumed as a plurality of self-driving vehicles 18. The administrator unit 39 includes the guide setting unit 47A, the abnormality detecting unit 47B, the non-overlapping setting unit 47C, and the route transmission unit 47D.

The guide setting unit 47A is configured to set a guide route for each of the self-driving vehicles 18. The abnormality detecting unit 47B is configured to obtain information showing presence of abnormality on parking assist.

The non-overlapping setting unit 47C is configured to, when abnormality on parking assist is informed, set a guide route for a particular vehicle, which indicates at least one self-driving vehicle 18 mapped to abnormality, to be a non-overlapping route as a guide route that does not overlap a guide route for another self-driving vehicle 18. The route transmission unit 47D is configured to, when the guide route or the non-overlapping route is set, transmit that route, i.e., the guide route or the non-overlapping route, to an self-driving vehicle 18 traveling along the set route.

According to such a configuration, since the guide route for the particular vehicle is set as the non-overlapping route, the particular vehicle can be prevented from coming into contact with another self-driving vehicle 18.

(2b) In one aspect of the disclosure, the administrator unit 39 further includes the stop transmission unit 47E. The stop transmission unit 47E is configured to transmit a stop command instructing stop operation to a plurality of self-driving vehicles 18 when abnormality on parking assist is informed.

According to such a configuration, a plurality of self-driving vehicles 18 can be stopped when abnormality is informed. Thus, control can be more safely performed. The plurality of self-driving vehicles 18 in this case includes at least an abnormal self-driving vehicle 18 and an self-driving vehicle 18 the guide route for which overlaps the guide route for the abnormal self-driving vehicle 18, or may be all self-driving vehicles 18 performing automated driving.

(2c) In one aspect of the disclosure, the administrator unit 39 further includes the stop determination unit 47F. The stop determination unit 47F is configured to determine whether the plurality of self-driving vehicles 18 are stopped after transmission of the stop command. The non-overlapping setting unit 47C is configured to, assuming an self-driving vehicle 18, which has been failed to be determined to stop within a predetermined determination time, is the particular vehicle, set a guide route for an self-driving vehicle other than the particular vehicle such that the guide route for the particular vehicle is the non-overlapping route.

According to such a configuration, a guide route for another self-driving vehicle 18 can be set while avoiding the guide route for the self-driving vehicle 18 that has been failed to be determined to stop.

(2d) In one aspect of the disclosure, the administrator unit 39 further includes the resolution detecting unit 47G. The resolution detecting unit 47G is configured to obtain information showing resolution of abnormality on parking assist. The guide setting unit 47A is configured to, when obtaining the information showing resolution of the abnormality, set guide routes to be allowed to overlap each other for a plurality of self-driving vehicles 18 in place of the non-overlapping route set by the non-overlapping setting unit 47C.

According to such a configuration, when abnormality is resolved, guide routes can be set to be allowed to overlap with each other in preference to parking efficiency.

(2e) In one aspect of the disclosure, the non-overlapping setting unit 47C is configured to set the non-overlapping route only for the particular vehicle when abnormality on parking assist is informed and when the abnormality is on an individual self-driving vehicle 18. The non-overlapping setting unit 47C is configured to set the non-overlapping route assuming any of a plurality of self-driving vehicles 18 is the particular vehicle when the abnormality is not an abnormality on individual self-driving vehicles 18.

According to such a configuration, since the self-driving vehicle 18 to be set as the particular vehicle can be changed depending on an area affected by the abnormality, safety and efficiency can be easily maintained in an abnormal state.

(2f) In one aspect of the disclosure, the non-overlapping setting unit 47C sets the non-overlapping route only for the particular vehicle when abnormality on parking assist is informed.

According to such a configuration, the non-overlapping route can be set for the particular vehicle while other vehicles are allowed to overlap with each other, leading to efficient path operation. Thus, safety and efficiency can be easily maintained in an abnormal state. Further, according to such a configuration, it is possible to reduce time required for loading-and-unloading of the self-driving vehicles 18 and thus reduce consumption of fuel or power of each self-driving vehicle 18.

(2g) The abnormality detecting unit 47B determines that communication delay occurs when a time difference between at a first timing at which positional information indicating a position of the self-driving vehicle 18 or a vehicle state indicating a state of the self-driving vehicle 18 is detected by at least one self-driving vehicle 18 and a second timing at which the positional information or the vehicle state is recognized by the abnormality detecting unit 47B exceeds a predetermined delay determination time.

According to such a configuration, it is possible to determine whether delay occurs, i.e., whether accurate automated driving control can be achieved by comparing the detection timing of the positional information or the vehicle state by the self-driving vehicle 18 to the detection timing thereof by the administrator unit 39. It is therefore possible to perform guide control of the self-driving vehicle 18 more safely.

### 3. Other Embodiments

Although one embodiment of the disclosure has been described hereinbefore, the disclosure is not limited thereto, and various modifications or alterations thereof can be made.

(3a-1) In the parking assist system 1 of the above-described embodiment, the processes of S2 and subsequent steps are performed for each self-driving vehicle 18 that has requested parking. In S7 performed when an self-driving vehicle 18 is determined to be abnormal, the stop transmission unit 47E of the administrator unit 39 transmits a stop command to all self-driving vehicles 18 in the parking lot. However, such a configuration is not limitative. A modification of the parking setting processing performed by the administrator unit 39 is described below.

In a parking assist system of the modification, the administrator unit 39 sends a stop command only to another self-driving vehicle 18 having a guide route overlapping with a guide route for an self-driving vehicle 18 determined to be abnormal. In addition, the administrator unit 39 sets a guide route for the abnormal self-driving vehicle 18 to be a non-overlapping route, and changes a guide route for a nonabnormal self-driving vehicle 18 so as not to overlap the non-overlapping route.

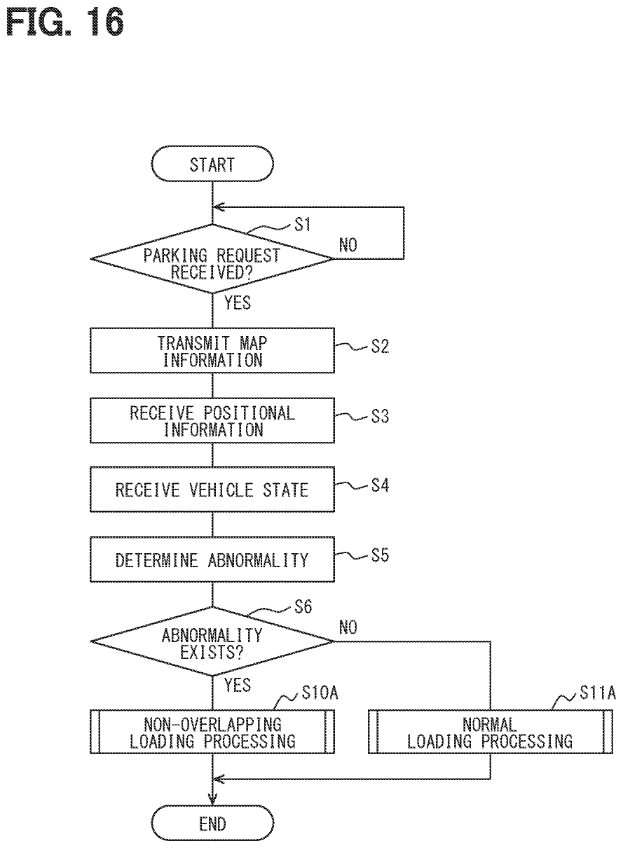

The modification of the parking setting processing performed by the administrator unit 39 is described with reference to FIGS. 16 to 18. In FIG. 16, determination is made on whether the normal loading processing or the non-overlapping loading processing is adopted as loading processing of the self-driving vehicle 18 that has performed a parking request. S1 to S6 in FIG. 16 are the same as S1 to S6, respectively, in the embodiment.

When abnormality is determined to exist in S6, the non-overlapping loading processing of S10A is performed on the self-driving vehicle 18 that has transmitted the parking request. When no abnormality is determined to exist, the normal loading processing of S11A is performed on the self-driving vehicle 18 that has transmitted the parking request. In the parking setting processing of FIG. 16, the modification is different from the embodiment in performing no processes of S7 to S9. In the parking setting processing of FIG. 16, no stop command is transmitted even if abnormality is determined to exist in S6.

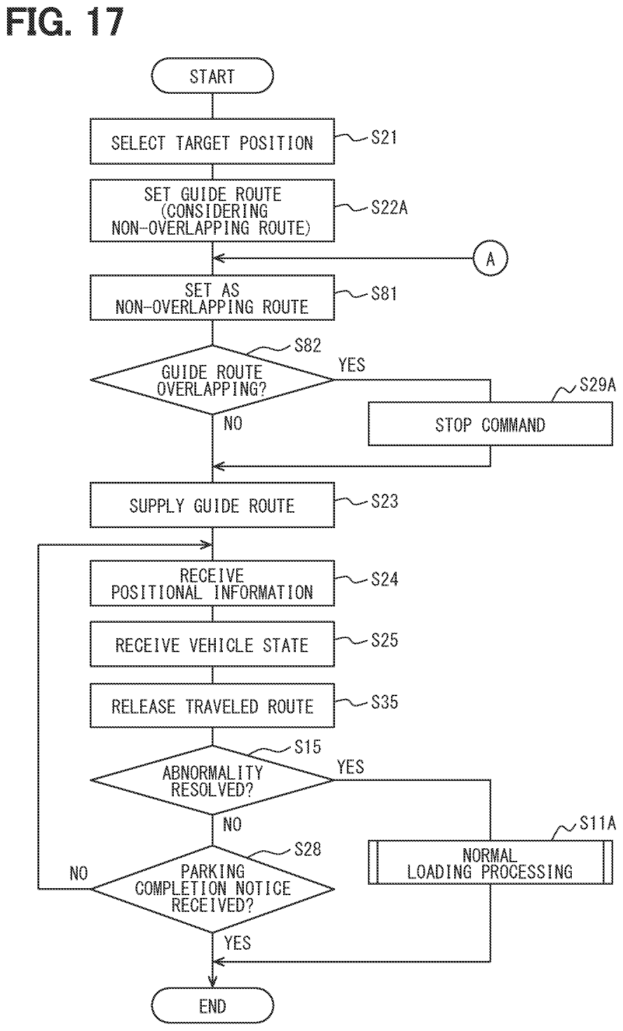

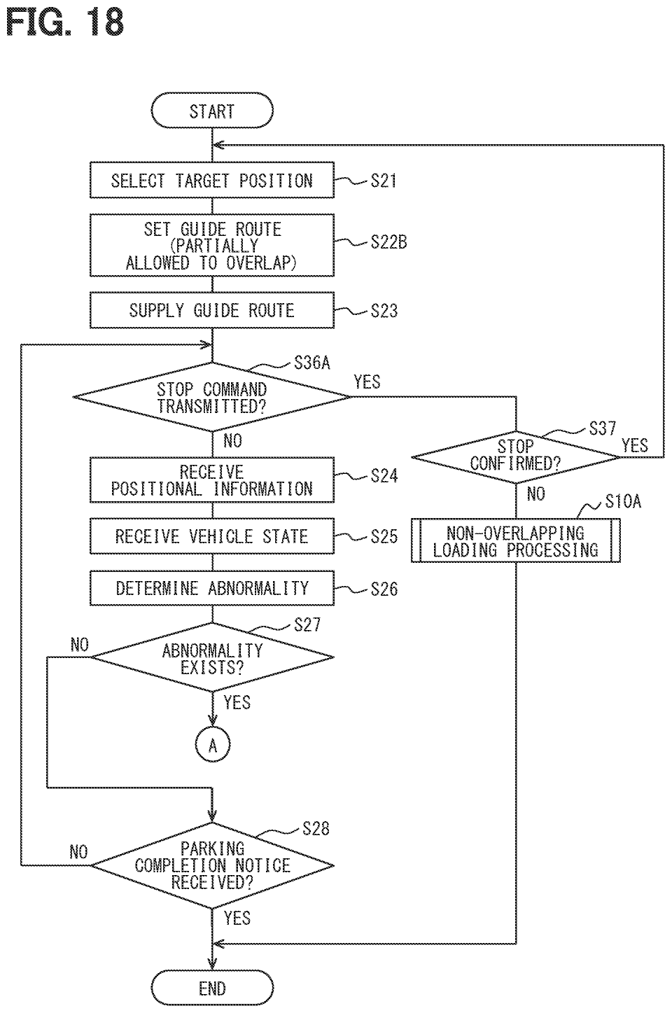

Non-overlapping loading processing performed by the administrator unit 39 in S10A is now described with reference to FIG. 17. The non-overlapping loading processing is performed when abnormality is determined to exist in S6 of FIG. 16. The processes of S15, S21 to S25, S28, and S35 are the same as those in the embodiment. The normal loading processing of S11A is the same as that of S11A of FIG. 16, and is described later with reference to FIG. 18.

As illustrated in FIG. 17, in S22A, the guide setting unit 47A sets a guide route to a parking position using the map information of the relevant parking lot. The memory 53 stores map information of the relevant parking lot, and whether each path is available as the guide route is mapped in the map information. Further, the memory 53 stores a guide route in association with an self-driving vehicle 18 for any of the self-driving vehicles 18 performing automated driving in the relevant parking lot.

When whether each path is available as the guide route is mapped, a plurality of paths may be collectively managed, or the inside of the parking lot may be divided into a plurality of blocks to manage each block. When the guide route to the parking position is set, the processing is passed to S81.

In S81, the non-overlapping setting unit 47C sets the set guide route as the non-overlapping route. The set guide route corresponds to the guide route set in S22A or the guide route that has been set in the normal loading processing and then changed to the non-overlapping route. In S81, the non-overlapping setting unit 47C accesses the memory 53 to set a path contained in the guide route for the relevant self-driving vehicle 18 to be unavailable. When the pass is set to be unavailable, another self-driving vehicle cannot set a guide route containing that path. When abnormality is resolved, or when the self-driving vehicle 18, for which the non-overlapping route has been set, passes through the path and that path is thus released, the guide setting unit 47A changes the path to be available.

In S82, the non-overlapping setting unit 47C determines whether the non-overlapping route set in S81 overlaps a guide route for another self-driving vehicle 18 based on the guide route for the self-driving vehicle 18 stored in the memory 53. If the non-overlapping route overlaps the guide route for another self-driving vehicle 8, the processing is passed to S29A. When another self-driving vehicle has been already set to a non-overlapping route, a path contained in the non-overlapping route is set unavailable in the map information and is thus not contained in the non-overlapping route for the relevant self-driving vehicle 18. In a case where the non-overlapping route overlaps the guide route for another self-driving vehicle 18 in S82, for example, the guide route for another self-driving vehicle 18 other than the non-overlapping route is first set, and then a non-overlapping route is set for an self-driving vehicle 18 in which abnormality has occurred.

In S29A, the stop transmission unit 47E transmits a stop command to another self-driving vehicle 18, the guide route for which overlaps the non-overlapping route. Since the memory 53 stores the self-driving vehicle 18 and the guide route in association with each other, the stop transmission unit 47E can specify a guide route overlapping the non-overlapping route to specify the self-driving vehicle 18 corresponding to the non-overlapping route.

When the non-overlapping route does not overlap the guide route for another self-driving vehicle 8 in S82, this processing is passed to S23. The processes of S23 and subsequent steps are the same as those in the embodiment except that S36 and S37 are omitted, and duplicated description is omitted.

The normal loading processing performed by the administrator unit 39 in S11A is described with reference to FIG. 18.

The normal loading processing is performed when no abnormality is determined to exist in S6 of FIG. 16. S21 to S28 and S37 are the same as those in the embodiment, and duplicate description is omitted. The process of S10A is the same as that of the non-overlapping loading processing of FIG. 17.

In S36A, the stop determination unit 47F determines whether a stop command is transmitted. The stop command corresponds to the command transmitted in S29A. The stop command is transmitted when abnormality occurs in another self-driving vehicle 18, and when a non-overlapping route for another self-driving vehicle 18 overlaps a guide route for an self-driving vehicle 18 to be an object of the normal loading processing. In other words, even if abnormality occurs in an self-driving vehicle 18 in the parking lot, the administrator unit 39 does not transmit the stop command to an self-driving vehicle 18, the guide route for which does not overlap the guide route for the self-driving vehicle 18 in which abnormality has occurred.

The abnormality detecting unit 47B performs abnormality determination in S26. The abnormality detecting unit 47B determines presence or absence of abnormality in S27. If abnormality is determined to exist, the processing is passed to S81 of the non-overlapping loading processing. In such a case, the self-driving vehicle 18 has selected only an available path to set the guide route in S22B. Hence, the set guide route is set as the non-overlapping route in S81 of the non-overlapping loading processing.

If no abnormality is determined to exist in S27, this processing is passed to S28. In S28, the administrator unit 39 determines whether a parking completion notice is received via the communication unit 49. If the parking completion notice is received, this processing is ended. If the parking completion notice is not received, the processing is returned to S36A.

(3a-2) According to such a configuration of the modification, since the guide route for the particular vehicle is set to be the non-overlapping route, the particular vehicle can be prevented from coming into contact with another self-driving vehicle 18.

(3a-3) Further, in the configuration of the above modification, the administrator unit 39 transmits a stop command only to an self-driving vehicle that travels a guide route overlapping a non-overlapping route.

According to such a configuration of the modification, when abnormality on parking assist is determined to exist, safety and efficiency can be easily maintained in an abnormal state by limiting the self-driving vehicle to which the stop command is transmitted.

(3a-4) In the configuration of the above modification, when a guide route for the self-driving vehicle 18 has been already set, the administrator unit 39 directly sets that guide route as the non-overlapping route.

According to such a configuration of the modification, even if delay or interruption occurs in communication between the administrator unit 39 and the self-driving vehicle 18, a plurality of self-driving vehicles 18 can be more safely moved.

(3a-5) In the configuration of the above modification, since the administrator unit 39 does not transmits the stop command to an self-driving vehicle 18 traveling the non-overlapping route, the self-driving vehicle 18 traveling the non-overlapping route does not receive the stop command. In addition, the self-driving vehicle 18 traveling the non-overlapping route rapidly reaches the target position and releases the non-overlapping route without stopping the traveling.

According to such a configuration of the modification, safety and efficiency can be more easily maintained in an abnormal state.

(3a-6) In the configuration of the above modification, the non-overlapping setting unit 47C of the administrator unit 39 is configured to change the guide route for another self-driving vehicle 18 without changing the guide route for the particular vehicle when determining that the guide route for the particular vehicle overlaps the guide route for another self-driving vehicle 18.

According to such a configuration of the modification, since the guide route for another nonabnormal self-driving vehicle 18 is changed assuming the abnormal vehicle is the particular vehicle, even if the guide route for the particular vehicle cannot be changed due to, for example, communication interruption, a plurality of self-driving vehicles 18 can be more safely guided.

(3b) Although the embodiment has been described with loading and unloading, the disclosure is not limited thereto. For example, the above configuration may be applied when the self-driving vehicle 18 is moved to another parking position in the parking lot. In detail, the administrator unit 39 may perform the processes of S3 and subsequent steps not only in the case of receiving the unloading request signal but also in the case of receiving a movement request signal in S61 of the unloading setting processing of FIG. 12.

The movement request signal is generated in the administrator unit 39 for a vehicle other than any vehicle to be loaded or unloaded when a loading request signal or an unloading request signal is received and when loading or unloading cannot be performed unless the vehicle other than the vehicle to be loaded or unloaded is moved.

(3c) In the embodiment, all guide routes are set to be non-overlapping routes assuming all self-driving vehicles 18 are abnormal only when an abnormality affecting the parking assist system 1 as a whole is detected. However, the non-overlapping setting unit 47C may be configured to set the non-overlapping routes assuming all the self-driving vehicles 18 are abnormal when some abnormality on parking assist is informed. In such a case, S8 and S9 may be omitted so that the non-overlapping loading processing is performed immediately upon receiving the stop command.

According to such a configuration, guide routes for all self-driving vehicles 18 can be set so as not to overlap each other when abnormality is informed. Thus, safety can be easily maintained in an abnormal state.

(3d) Although a guide route for the abnormal self-driving vehicle 18 is to be a non-overlapping route, and the guide route for the nonabnormal self-driving vehicle 18 is changed so as not to overlap the non-overlapping route in the embodiment, such a configuration is not limitative. If the administrator unit 39 can communicate with the abnormal self-driving vehicle 18, the administrator unit 39 may set the non-overlapping route by changing the guide route for the abnormal self-driving vehicle 18 so as not to overlap the route for another self-driving vehicle 18.

At this time, it is preferred that the guide setting unit 47A mainly performs the normal loading processing and the normal unloading processing, and the non-overlapping setting unit 47C mainly performs the non-overlapping loading processing and the non-overlapping unloading processing.

In such a case, for example, as illustrated in FIG. 5, when A1 is set as a guide route for an abnormal self-driving vehicle 18, since A1 overlaps the routes B1 and B2 being guide routes for other self-driving vehicles 18, the guide route is changed to, for example, a route A2 to avoid such overlapping. At this time, the route A2 is also set to avoid overlapping with the route B3.

According to such a configuration, since another nonabnormal self-driving vehicle 18 need not change the guide route, influence on another nonabnormal self-driving vehicle 18 can be minimized.

(3e) A plurality of functions exhibited by one component in the embodiment may be achieved by a plurality of components, or one function exhibited by one component may be achieved by a plurality of components. A plurality of functions exhibited by a plurality of components may be achieved by one component, or one function achieved by a plurality of components may be achieved by one component. A configuration of the embodiment may be partially omitted. At least part of a configuration of the embodiment may be added to or substituted for another configuration of the embodiment.

(3f) The disclosure can be implemented in various modes, in addition to the parking assist system 1, such as the administrator unit 39 as a component of the parking assist system 1, a program to operate a computer as that administrator unit 39 or the like, a non-transitory tangible storage medium such as a semiconductor memory recording the program, and a parking assist method.

1. A parking assist device configured to assist auto-parking for a plurality of self-driving vehicles, the device comprising:
a guide setting unit configured to set a guide route for each of the plurality of self-driving vehicles, the plurality of self-driving vehicles configured to perform automated driving in a parking lot according to the guide route set by the guide setting unit;
an abnormality detecting unit configured to detect abnormality relating to parking assist;
a non-overlapping setting unit configured to, when the abnormality concerning a particular vehicle of the plurality of self-driving vehicle is detected, set a non-overlapping route, as the guide route, for the particular vehicle such that the non-overlapping route does not overlap with any other guide routes set for remaining self-driving vehicles; and
a route transmission unit configured to transmit the guide route to each of the plurality of self-driving vehicles, wherein
the guide setting unit is configured to set the guide route such that the guide route for each of the remaining self-driving vehicles is allowed to overlap with each other except the non-overlapping route.

2. The parking assist device according to claim 1, further comprising
a stop transmission unit configured to transmit stop commands to all the plurality of self-driving vehicles when the abnormality is detected.

3. The parking assist device according to claim 2, further comprising
a stop determination unit configured to determine whether the plurality of self-driving vehicles stopped after the stop commands were transmitted, wherein
one of the plurality of self-driving vehicles is determined to be the particular vehicle when the one of the plurality of self-driving vehicles does not stop within a predetermined determination time after the stop commands were transmitted, and
the non-overlapping setting unit is configured to set the guide route for each of the remaining self-driving vehicles such that the guide route for the particular vehicle turns to be the non-overlapping route.

4. The parking assist device according to claim 1, further comprising
a resolution detecting unit configured to determine whether the abnormality concerning the particular vehicle is resolved, wherein
the guide setting unit is configured to, when the abnormality is determined to be resolved, set the guide route other than the non-overlapping route for all the plurality of self-driving vehicles including the particular vehicle such that the guide route for each of the plurality of self-driving vehicles is allowed to overlap with each other.

5. The parking assist device according to claim 1, wherein
the non-overlapping setting unit is configured to set the non-overlapping route for all the plurality of self-driving vehicles by regarding each of the plurality of self-driving vehicles as the particular vehicle when the abnormality is detected.

6. The parking assist device according to claim 1, wherein
the non-overlapping setting unit is configured to set the non-overlapping route only for the particular vehicle when the abnormality is detected.

7. The parking assist device according to claim 1, wherein
the non-overlapping setting unit is configured to:
set the non-overlapping route only for the particular vehicle when the detected abnormality is caused by the particular vehicle; and
set the non-overlapping route for all the plurality of self-driving vehicles by regarding each of the plurality of self-driving vehicles as the particular vehicle when the detected abnormality is not caused by the particular vehicle.

8. The parking assist device according to claim 1, further comprising
a memory configured to store information that the abnormality occurs, wherein
the abnormality detecting unit is configured to:
determine whether the abnormality occurs by determining whether delay occurs in communication with at least one of the plurality of self-driving vehicles or whether communication with all the plurality of self-driving vehicles is interrupted; and
store the information that the abnormality occurs in the memory upon determining that the abnormality occurs.

9. The parking assist device according to claim 8, wherein
the abnormality detecting unit is configured to determine that delay in communication with at least one of the plurality of self-driving vehicles occurs when a time difference between a first timing at which positional information or a vehicle state of the at least one of the plurality of self-driving vehicles is detected by the at least one of the self-driving vehicles and a second timing at which the positional information or the vehicle state is recognized by the abnormality detecting unit exceeds a predetermined delay determination time.

10. The parking assist device according to claim 1, further comprising
a memory configured to store information that the abnormality occurs, wherein
the abnormality detecting unit is configured to:
determine whether the abnormality occurs by comparing a sensed value relating to a vehicle state of each of the plurality of self-driving vehicles transmitted therefrom to a predetermined reference value or a predetermined reference range; and
store the information that the abnormality occurs in the memory upon determining that the abnormality occurs.

11. The parking assist device according to claim 1, further comprising
a memory configured to store information that the abnormality occurs, wherein
the abnormality detecting unit is configured to:
determine that the abnormality occurs when receiving a failure diagnosis result indicative of occurrence of a failure in one of the plurality of self-driving vehicles therefrom; and
store the information that the abnormality occurs in the memory upon determining that the abnormality occurs.

12. The parking assist device according to claim 1, wherein
the non-overlapping setting unit is configured to determine whether the guide route that has been already set for the particular vehicle overlaps with the guide route for each of the remaining self-driving vehicles when the abnormality concerning the particular vehicle is detected.

13. The parking assist device according to claim 12, wherein
the non-overlapping setting unit is configured to change the guide route for each of the remaining self-driving vehicles without changing the guide route for the particular vehicle upon determining that the guide route that has been already set for the particular vehicle overlaps with the guide route for each of the remaining self-driving vehicles.

14. The parking assist device according to claim 1, wherein
the guide setting unit is configured to:
specify a traveled portion of the non-overlapping route along which the particular vehicle has already traveled based on positional information of the particular vehicle; and
set the guide route for each of the remaining self-driving vehicles to allow the guide route to overlap with the specified traveled portion.

15. A parking assist device configured to assist auto-parking for a plurality of self-driving vehicles, the device comprising:
at least one processor; and
at least one memory coupled to the at least one processor and storing program instructions that, when executed by the at least one processor, cause the at least one processor to:
set a guide route for each of the plurality of self-driving vehicles, the plurality of self-driving vehicles configured to perform automated driving in a parking lot according to the set guide route;
detect abnormality relating to parking assist;
when the abnormality concerning a particular vehicle of the plurality of self-driving vehicle is detected, set a non-overlapping route, as the guide route, for the particular vehicle such that the non-overlapping route does not overlap with any other guide routes set for remaining self-driving vehicles; and
transmit the guide route to each of the plurality of self-driving vehicles, wherein
the program instructions further cause the at least one processor to set the guide route such that the guide route for each of the remaining self-driving vehicles is allowed to overlap with each other except the non-overlapping route.
